SEQUENCE LISTING (10 sequences)

SEQ ID NO: 1 - protein, 327 aa, Galleria mellonella
FIATHAFGLRLIPGSLGVISNLFWNPLFQGRTQLVEQFNGQRTKLKTADGNTIDTMFVDHRNQSTKGKYLWCCEGNSGFYEIGIMATPMKAGYSALGWNHPGFAGSTGLPYPSQEQNAIDAVMQYAINELNFQPENVVMFGWSIGGYSATWAAINYPVKALVLDATFDDLLPLAQNVMPSSWSLLVKEVVRSYVNLNIVEMLKKYTGPVHLVRRTEDEVICLIPGVTSTNRGNYLVMSLIEHRHPFEDSENEAAWKKALHSHVENLEAKRPFVDSGDLTIYDIRAMTLISKYMSDYQSTHCVPLPAEHFESVMNFINTSKYNNQALK

SEQ ID NO: 2 - protein, 232 aa, Piscinibacter sakaiensis
RPSGYGAGTVYYPTNAGGTVGAIAIVPGYTARQSSIKWWGPRLASHGFVVITIDTNSTLDQPSSRSSQQMAALRQVASLNGTSSSPIYGKVDTARMGVMGWSMGGGGSLISAANNPSLKAAAPQAPWDSSTNFSSVTVPTLIFACENDSIAPVNSSALPIYDSMSRNAKQFLEINGGSHSCANSGNSNQALIGKKGVAWMKRFMDNDTRYSTFACENPNSTRVSDFRTANCS

SEQ ID NO: 3 - protein, 249 aa, Thermobifida fusca
RLSASFGFFFTIYYPRENNTYGAVAISPGYTGTEASIAWLGERIASHGFVVITIDTITTLDQPDSRAEQLNAALHMINRASSTVRSRIDSSRLAVMGHSMGGGGSLRLASQRPDLKAAIPLTPWHLNKWSSVTVPTLIIGADLDTIAPVATHAKPFYNSLPSSISKAYLELDGATHFAPNIPNKIIGKYSVAWLKRFVDNDTRYTQFLCPGPRDGLFGEVEEYRSTCPFYPNSSSVDKLAAALEHHHHH

SEQ ID NO: 4 - protein, 231 aa, Thermobifida halotolerans
RLQARGFGGGTIYYPTDNNTFGAVAISPGYTGTQSSISWLGERLASHGFVVMTIDTNTTLDQPDSRASQLDAALDYMVEDSSYSVRNRIDSSRLAAMGHSMGGGGTLRLAERRPDLQAAIPLTPWHTDKTWGSVRVPTLIIGAENDTIASVRSHSEPFYNSLPGSLDKAYLELDGASHFAPNLSNTTIAKYSISWLKRFVDDDTRYTQFLCPGPSTGWGSDVEEYRSTCPF

SEQ ID NO: 5 - protein, 208 aa, Galleria mellonella
MTNKVSKEWFMQMPWGKVAMISWGESSKPPILMVHGYMDTAATFTRLLEHMPDTYYYVSFDFPGHGKSEYLPVAPPSTQTLLVEVVRRIVDHMGWESFIFLAHSMAFVIGLCYNNAFPGRIERMIAIDPTIPLSAHYNVSHNFQWWFKFNYQYYYDSYHKNYKNMKNASKLYTYEQAVAAMMKARSLTREQDDIPIGHYAYDLLHLVT

SEQ ID NO: 6 - protein, 220 aa, Galleria mellonella
MEPNPVIIAATAKQTAVLIFLHGLGDTGHGWASTIAAIRGPHVKVICPTAATIPVTLNAGFRMPSWFDLRTLDATAPEDEEGILRATTLVHGLISDEVKAGTPANRVLLGGFSQGGALALHAALTYPQPLAGVMSLSCWLPRHAHFPDAVKAPLDLPIFQAHGDCDPVVPFKWGQMTASFLKTFMKNIDFTTYQGLTHSSSEAELKDMRAFIERTLPSVK

SEQ ID NO: 7 - protein, 503 aa, Galleria mellonella
MKLFFQCLFSPRLYKIYRDGSSDTMYQPLRLEKLADKVITSAHTMMNIAIYTSPFICMYIYKRGFSVIEENKYALVRFFGGIGCLLALSYVIRGLGRFYNQKYVDFVKALKSPMTDKGSYLEGIRKYDFEFYAWPTTFIMPPKSSPPLLQKNPFTNCANSDRPLYQRLPIQVLAFIATHAFGLRLIYPGSLGVISNLFWNPLFQGRTQLVEQFNGQRTKLKTADGNTIDTMFVDHRNQSTKGKYLVVCCEGNSGFYEIGIMATPMKAGYSALGWNHPGFAGSTGLPYPSQEQNAIDAVMQYAINELNFQPENVVMFGWSIGGYSATWAAINYPVKALVLDATFDDLLPLAQNVMPSSWSLLVKEVVRSYVDLNIVEMLKKYTGPVHLVRRTEDEVICLIPGVTSTNRGNYLVMSLIEHRHPFEDSENEAAWKKALHSHVENLEAKRPFVDSGDLTIYDIRAMTLISKYMSDYQSTHCVPLPAEHFESVMNFINTSKYNNQAKL

SEQ ID NO: 8 - protein, 287 aa, Galleria mellonella
MDSLQLVSSNKIFGGYQKVYAHESSELKCKMNFSIYLPPQADGDNVKLPVIFYLSGLTCTEQNFITKSGFQRYAAQHGIIVVSPDTSPRGVKIPGDDDSWDFGVSAGFYLDAVMDPWSKHYRMGSYVTKELYEIIQSAFSNLVDPTKFGIMGHSMGGHGALVSTLRNPGLFKSVSAFAPICNPSACPWGEKAFTGYLGKDKNQWAEWDATELVKKYDGPPLTLLIDQGAGDKFYKEKQLLPENLVEACRSVGVPVILNLREDYDHSYYYISTYIGEHFDFHAKILKA

SEQ ID NO: 9 - protein, 433 aa, Galleria mellonella
MSTVLLAVIAVILCVLFRILNVNSQPQKPVIYGRDRSFIENILFISPFLNDPYIPTRLWGFSGHVQTILHSLIGRVRCPWPIGGRVSLVLPDRSTLTYDLYEPVGSEHEDDVTVAICPGIGNTSESVYIRTYVHYSQCHGYRCAVLNHIGALNSVPVTGSRIFSYGHTDDYNYMIESILERYPQTKIILVGFSLGGNLVTKYLGEDRKRPSNIIGGISICQGYNAIDTMVYLLQWQNFRRFYLYIMTDNYRNIITRHKRMLLSPEMKSRHSLDEKMIVSAGTLPDLDEAYSRRIHGFDTVADLYKWSSSAFYLDKIKTPMIFINARDDPIVPEPLLPIIREFVSSHDKAMYLELAHGGHLGFYEGGLIYANPVNWLDRALVGLTGGMLMAHNKCSPKDAAMVSDCTVSDDEPDLIKSATIVYRDPLEKLQQAY

SEQ ID NO: 10 - protein, 290 aa, Piscinibacter sakaiensis
MNFPRASRLMQAAVLGGLMAVSAAATAQTNPYARGPNPTAASLEASAGPFTVRSFTVSRPSGYGAGTVYYPTNAGGTVGAIAIVPGYTARQSSIKWWGPRLASHGFVVITIDTNSTLDQPSSRSSQQMAALRQVASLNGTSSSPIYGKVDTARMGVMGWSMGGGGSLISAANNPSLKAAAPQAPWDSSTNFSSVTVPTLIFACENDSIAPVNSSALPIYDSMSRNAKQFLEINGGSHSCANSGNSNQALIGKKGVAWMKRFMDNDTRYSTFACENPNSTRVSDFRTANCS

(19) United States
(12) Patent Application Publication
(10) Pub. No.: US 2026/0022227 A1
(43) Pub. Date: Jan. 22, 2026

(54) METHOD FOR DEGRADING AND DECOMPOSING PLASTIC USING ENZYMES EXPRESSED BY LEPIDOPTERA

(71) Applicant: THE AMERICAN UNIVERSITY IN CAIRO, New Cairo (EG)

(72) Inventors: Joseph Nashaat BOCTOR, New Cairo (EG); Walid FOUAD, New Cairo (EG); Elham MAHMOUD, New Cairo (EG)

(73) Assignee: THE AMERICAN UNIVERSITY IN CAIRO, New Cairo (EG)

(21) Appl. No.: 18/777,135

(22) Filed: Jul. 18, 2024

Related U.S. Application Data
(60) Provisional application No. 63/467,751, filed on May 19, 2023.

(51) Int. Cl. C08J 11/10

(52) U.S. Cl. CPC C08J 11/105

(57) ABSTRACT

The invention pertains to a method for degrading plastic using enzymes encoded by insects in the order Lepidoptera, to engineered enzymes structurally and functionally distinct from their natural counterparts and to recombinant organisms or cells expressing the plastic-degrading enzymes or their variants.

### CROSS-REFERENCE TO A RELATED APPLICATION

This application is related to and claims priority to U.S. Provisional Application 63/467,751 filed May 19, 2023 which is incorporated by reference for all purposes.

### REFERENCE TO A SEQUENCE LISTING

In accordance with 37 CFR § 1.831-1835 and 37 CFR § 1.77(b)(5), the specification makes reference to a Sequence Listing submitted electronically as a .xml file named “553483US_ST26. This .xml file was generated on Jul. 18, 2024 and is 12,697 bytes in size. The entire contents of the Sequence Listing are hereby incorporated by reference. Other sequences described in the disclosure by Accession numbers are hereby incorporated by reference to the sequences described by the corresponding Accession numbers.

### BACKGROUND OF THE INVENTION

### Field of the Invention

The technology disclosed herein relates to the fields of molecular biology, chemistry, and environmental science. More specifically, it involves the use of enzymes derived from Lepidoptera to degrade synthetic plastic polymers. The enzymatic breakdown of hard to degrade or overabundant plastics represents a promising approach for mitigating plastic waste accumulation and environmental pollution caused by on-biodegradable petrochemical-based plastics.

### Description of Related Art

Various Lepidoptera enzymes have been described which are presumably or arguably derived from gut bacteria in insects such as Galleria mellonella; see Bombelli, P, et al., Polyethylene biodegradation by caterpillars of the wax moth Galleria mellonella, CURR. BIOL., 2017 Apr. 24; 27(8):R292-R293. doi: 10.1016/j.cub.2017.02.060. Somia Liaqat, et al., Microbial ecology: A new perspective of plastic degradation. PURE APPL. BIOL. 9(4):2138-215. 2020.

In contrast to enzymes expressed by gut prokaryotes such as those in the digestive systems of Lepidoptera, an enzyme expressed by a eukaryote, such as Lepidoptera, may have (i) higher stability under a broad range of harsh physical conditions due to more complex protein folding machinery of eukaryotes; (ii) greater efficiency and improved substrate turnover rates; (iii) greater specificity for a substrate; (iv) larger size which resists alterations in temperature or pH; (v) a more complex structure associated with more complex activity; (vi) a greater adaptability to changing environments; (vii) a longer life span than prokaryotic enzymes; (viii) better regulation of enzymatic activity and a more stable degree of activity; (ix) lower toxicity; (x) enhanced recognition of more complex substrates; (xi) different post translation modifications associated with stability and activity, and/or (xii) increased predictability and reliability for environmental, commercial, or industrial applications.

The worldwide need for more effective and efficient ways to degrade plastic polymers is further described by reference to FIGS. 1-4.

FIG. 1 shows a World map for plastic waste emitted per capita. FIG. 2 shows the fate of produced plastic and its advancement through time. FIG. 3 describes a percentage of mismanaged plastic waste per selected country per capita. FIG. 4 describes a history of plastic biodegradation. Many degrading organisms have been reported, with versatile properties, different efficiencies and spectrum towards specific types of plastics (Sivan, 2011). FIG. 4 shows a simple history timeline of plastic biodegradation milestones.

Disposable plastic products and other artificial plastic wastes represent a major environmental problem due to their non-biodegradability and long persistence in the environment. Conventional methods of disposing of plastic include burning it, burying it in a landfill, or simply letting it accumulate in the environment, such as in the so-called Great Pacific Garbage Patch or in landfills or other waste dumps.

Burning plastic releases toxic fumes and gases such as dioxins or furins and produces ash, which can contain heavy metals which require additional handling and disposal.

Burying plastic in a landfill is costly as the landfill must be created and maintained, takes up space and time as many plastics do not degrade for hundreds of years, and can result in leaching of harmful chemicals from the landfill into the environment.

As can be appreciated from the problems and challenges described above, there is a need for more economic, sustainable, and environmentally friendly ways to dispose of plastic wastes.

### BRIEF SUMMARY OF THE INVENTION

The foregoing paragraphs have been provided by way of general introduction and are not intended to limit the scope of the following claims. The described embodiments, together with further advantages, will be best understood by reference to the following description and embodiments.

One aspect of the invention is directed to a method for degrading plastic by contacting it with one or more enzymes encoded and expressed by insects in the order Lepidoptera, such as Galleria mellonella known as the greater wax moth. This method may be performed with the enzymes as they naturally occur or by enzymatically active fragments or domains, motifs or segments of the longer enzymes or by engineered variants of the naturally occurring enzymes. A variant may be identified or characterized by a degree of sequence identity or similarity to a reference protein (such as a native protein expressed by G. mellonella) as described below.

Another aspect of the invention is an engineered enzyme which is structurally and/or functionally distinct from its natural counterpart.

The invention also pertains to recombinant cells, including prokaryotic microorganisms and eukaryotic cells, including yeast, fungi, plant, insect, and other animal cells, which encode and express the plastic-degrading enzymes. Such cells may be produced using recombinant nucleic acid methodologies known in the art. Nucleic acid sequences encoding the enzymes disclosed herein may be deduced and reverse transcribed from the amino acid sequences disclosed herein. In some embodiments, the codon frequencies of a nucleic acid used to encode and express an enzyme may be adjusted to those optimal for protein expression in a particular organism.

Embodiments of the invention include, but are not limited to, the following.

1. A method for degrading plastic comprising contacting a plastic with one or more plastic-degrading enzymes expressed by the genome of the order Lepidoptera, or an enzymatically active fragment or domain thereof, or a variant thereof having at least 60, 65, 70, 75, 80, 85, 90, 95, 99, <100% sequence identity thereto, for a time and under conditions suitable for degrading the plastic.
2. The method of embodiment 1 which comprises contacting the plastic with plastic-degrading enzymes that consist essentially of, or that consist of, those expressed by the genome of the order Lepidoptera.
3. The method of embodiments 1 or 2, wherein the plastic comprises low density polyethylene (LDPE) or high density polyethylene (HDPE).
4. The method of embodiments 1 or 2, wherein the plastic comprises polyethylene terephthalate (PET).
5. The method of embodiments 1 or 2, wherein the plastic comprises polylactic acid (PLA).
6. The method of embodiments 1 or 2, wherein the plastic comprises mono(2-hydroxyethyl) terephthalate (MHET).
7. The method of embodiments 1 or 2, wherein the plastic comprises polypropylene (PP).
8. The method of embodiments 1 or 2, wherein the plastic comprises polystyrene (PS).
9. The method of embodiments 1 or 2, wherein the plastic comprises polyvinyl chloride (PVC).
10. The method of any one of embodiments 1-9, wherein the one or more plastic degrading enzymes are expressed in the family Pyralidae.
11. The method any one of embodiments 1-9, wherein the one or more plastic degrading enzymes are expressed in the genus Galleria.
12. The method any one of embodiments 1-9, wherein the one or more plastic degrading enzymes are expressed in the species Galleria mellonella.
13. The method of any one of embodiments 1-12, wherein the one or more plastic degrading enzymes are identified by XP_026749410.1, XP_026762525.1, XP_026758376.1, XP_026764270.1, or XP_026756911.1.
14. The method of any one of embodiments 1-13, wherein the plastic degrading enzyme comprises a PFAM motif that is:
PF00561 (alpha/beta hydrolase fold),
PF12697 (alpha/beta hydrolase family),
PF05057 & Putative serine esterase (DUF676),
PF07819 (PGAP1-like protein),
PF12695 (alpha/beta hydrolase family, serine aminopeptidase)
PF00326, (prolyl oligopeptidase family),
PF12146 (serine aminopeptidase, S33),
PF05448 (cetyl xylan esterase, AXE1) or
PF01083 (Cutinase).
   15. The method of any one of embodiments 1-14, wherein the one or more enzymes comprise an active site comprising a triad of discontinuous amino acid residues consisting of one, two, or three of Ser, His and Asp.
   16. The method of any one of embodiments 1-15, wherein the one or more enzymes comprise a catalytic triad of amino acid residues consisting of Ser, His and Asp, substantially as aligned with a triad of amino acid residues consisting of Ser160, His237 and Asp206 in the poly(ethylene terephthalate)ase (PETase) of Ideonella sakaiensis accession number GAP38373.
   17. The method of any one of embodiments 1-16, wherein the one or more plastic degrading enzymes exert carboxylesterase activity.
   18. The method of any one of embodiments 1-17, wherein the one or more plastic degrading enzymes exert lipase activity.
   19. The method of any one of embodiments 1-17, wherein the one or more plastic degrading enzymes exert hydrolase activity.
   20. The method of any one of embodiments 1-19, wherein the one or more plastic-degrading enzymes are isolated from a cell or from a cell-free system.
   21. The method of embodiment 1-19, wherein the one or more plastic degrading enzymes are expressed in bacteria or another prokaryote.
   22. The method of embodiment 1-19, wherein the one or more plastic degrading enzymes are expressed in yeast, fungi, insects, or another eukaryote.
   23. The method of any one of embodiments 1-19, wherein the one or more plastic degrading enzymes are expressed in an insect of order Lepidoptera.
   24. The method of any one of embodiments 1-19, wherein the one or more plastic-degrading enzymes are expressed in Lepidoptera or other insect larvae.
   25. The method of any one of embodiments 1-24, wherein the one or more plastic-degrading enzymes are expressed in Lepidoptera larvae which have been engineered to express said plastic-degrading enzymes in higher or lower amounts or express fragments, domains, or variants of said enzymes having a higher or lower specific enzymatic activity for degrading plastic, a higher or lower thermostability, higher or lower enzymatic stability to acidic or basic pH or higher and lower stability to environmental conditions.
   26. The method of any one of embodiments 1-25, wherein said contacting is done at an acid pH ranging from pH<3 to pH 7 and/or at a temperature ranging from 25-60 degrees Celsius.
   27. The method of any one of embodiments 1-25, wherein said contacting is done at a basic pH ranging from >pH7 to >pH 10.
   28. The method of any one of embodiments 1-27, further comprising physically, photonically, chemically, or biologically degrading the plastic during or prior to contacting it with the one or more enzymes.
   29. An engineered enzyme that has an amino acid sequence that is at least 60, 65, 70, 75, 80, 85, 90, 95, 99, <100% identical to an enzyme expressed in the order Lepidoptera that degrades plastic, or an enzymatically active fragment or domain or variant thereof.
   30. The engineered enzyme of embodiment 29 that digests or degrades low density polyethylene (LDPE) or high density polyethylene (HDPE).
   31. The engineered enzyme of embodiment 29 that digests or degrades polyethylene terephthalate (PET).
   32. The engineered enzyme of embodiment 29 that digests or degrades polylactic acid (PLA).
   33. The engineered enzyme of embodiment 29 that digests or degrades mono(2-hydroxyethyl) terephthalate (MHET).
   34. The engineered enzyme of embodiment 29 that digests or degrades polypropylene (PP).
   35. The engineered enzyme of embodiment 29 that digests or degrades (PS).
   36. The engineered enzyme of embodiment 29 that digests or degrades (PVC).
   37. The engineered enzyme of any one of embodiments 29-36 that is derived from a sequence <100% identical to XP_026749410.1, XP_026762525.1, XP_026758376.1, XP_026764270.1, and XP_026756911.1.
   38. The engineered enzyme of any one of embodiments 29-37 that comprises a PFAM motif that comprises:
PF00561 (alpha/beta hydrolase fold),
PF12697 (alpha/beta hydrolase family),
PF05057 & Putative serine esterase (DUF676),
PF07819 (PGAP1-like protein),
PF12695 (alpha/beta hydrolase family, serine aminopeptidase)
PF00326, (prolyl oligopeptidase family),
PF12146 (serine aminopeptidase, S33),
PF05448 (cetyl xylan esterase, AXE1) or
PF01083 (Cutinase).
   39. The engineered enzyme of any one of embodiments 29-38 that comprises an active site comprising a triad of discontinuous amino acid residues consisting of Ser, His and Asp.
   40. The engineered enzyme of any one of embodiments 29-39 that comprises a catalytic triad of amino acid residues consisting of Ser, His and Asp, substantially as aligned with a triad of amino acid residues consisting of Ser160, His237 and Asp206 in the poly(ethylene terephthalate)ase (PETase) of Ideonella sakaiensis accession number GAP38373.
   41. The engineered enzyme of any one of embodiments 29-40 that has carboxylesterase activity.
   42. The engineered enzyme of any one of embodiments 29-41 that has lipase activity.
   43. The engineered enzyme of any one of embodiments 29-42 that has hydrolase activity.
   44. The engineered enzyme of any one of embodiments 29-43 that has a higher specific activity that has been engineered to alter its physical, chemical, or biological properties toward degrading plastic as compared to an unmodified parent enzyme.
   45. The engineered enzyme of any one of embodiments 29-44 that has a higher specific activity than the corresponding enzyme expressed in the order Lepidoptera.
   46. The engineered enzyme of any one of embodiments 29-45 that has a higher thermostability, higher enzymatic stability to acidic or basic pH, or higher stability to environmental conditions than the corresponding enzyme expressed in the order Lepidoptera.
   47. A composition comprising a plastic-degrading enzyme expressed by the order Lepidoptera or a fragment or domain thereof, or an engineered enzyme that has an amino acid sequence that is at least 60, 65, 70, 75, 80, 85, 90, 95, 99, <100% identical to an enzyme expressed by the genome of the order Lepidoptera and at least one carrier or enzymatic stabilizer or active agent that accelerates or modulates degradation of the plastic. Such an active agent may include a biodegradable additive such as a starch-based, cellulose-based, vegetable oil-based additive or mixtures thereof.
   These additives create structural defects, increase hydrophilicity, and provide accessible carbon sources, facilitating microbial colonization and enzymatic degradation of the plastic [1,5].
   48. The composition of embodiment 47, wherein the plastic-degrading enzymes consists essentially of, or consists of, those expressed by the genome of the order Lepidoptera.
   50. A cell or organism transformed with a nucleic acid which expresses a plastic-degrading enzyme expressed by the order Lepidoptera or which expresses an engineered enzyme that has an amino acid sequence that is at least 60, 65, 70, 75, 80, 85, 90, 95, 99, <100% identical to an enzyme expressed in the order Lepidoptera.
   51. The cell or organism of embodiment 50 that is a prokaryote.
   52. The cell or organism of embodiment 50 that is a yeast, fungi or other eukaryote.
   53. The cell or organism of embodiment 50 that is an insect.
   54. The cell or organism of embodiment 50 that is an insect larva.
   55. The cell or organism of embodiment 50 that is Lepidoptera, Pyralidae, or Galleria.
   56. An animal or plant comprising, or encoding and expressing, one or more plastic-degrading enzymes expressed by the genome of Lepidoptera.
   57. A cell or organism that is Lepidoptera, Pyralidae, or Galleria, wherein expression of a plastic degrading enzyme has been knocked out.

### BRIEF DESCRIPTION OF THE DRAWINGS

The application file contains at least one drawing executed in color. Copies of this patent or patent application publication with color drawing(s) will be provided by the Office upon request and payment of the necessary fee.

FIG. 1. World map for plastic waste emitted/capita.

FIG. 2. The fate of produced plastic and its advancement through time.

FIG. 3. Mismanaged percentage of plastic waste per selected country/capita.

FIG. 4. History of plastic biodegradation.

FIG. 5. Showing the degradation steps and mechanism by Ideonella sakaiensis.

FIGS. 6A-6D. Structural differences between PETase and TfCut2 enzymes.

FIG. 7. Phylogenetic tree of 38 functionally characterized plastic degrading enzymes.

FIG. 8. Phylogenetic tree between functional Group A and G. mellonella lipases.

FIG. 9. Unrooted phylogenetic tree of 38 functionally characterized plastic degrading enzymes with Lipase (1,3) enzyme families from the greater wax moth.

FIG. 10. Phylogenetic tree of carboxylesterase family enzymes of G. mellonella against Group B of the functionally characterized enzymes.

FIG. 11. Unrooted phylogenetic tree for carboxylesterase family enzymes of the greater wax moth and 38 functionally characterized enzymes.

FIG. 12A. Candidate lipases from G. mellonella phylogenetically close to functionally characterized PET degrading enzymes.

FIG. 12B. Candidate carboxylesterases from G. mellonella phylogenetically close to functionally characterized PET degrading enzymes.

FIG. 13. Multiple sequence alignment of candidate enzymes from the greater wax moth and functionally characterized enzymes for plastic degradation. The alignments from top (FI - - - ATHFIA” at positions 2190221 . . . ) to bottom (RLQ . . . ) are described by SEQ ID NOS: 1-4, respectively. The longer sequence in XP_026758376.1 containing “FIA . . . ” is described by SEQ ID NO: 7.

FIG. 14A-14D. Effect of PETase and MHETase as positive controls on selected plastic polymers. a) PET b) PLA c) LDPE d) HDPE.

FIG. 15A-15D. Effect of G. mellonella potential plastic degrading enzymes on selected plastic polymers after 1 week. a) PET b) PLA c) LDPE d) HDPE.

FIG. 16A-16D. Effect of G. mellonella potential plastic degrading enzymes on selected plastic polymers after 2 weeks. a) PET b) PLA c) LDPE d) HDPE

FIG. 17. Positive control enzymes impact vs negative control on PET polymer FTIR spectrum

FIG. 18. FTIR overlaid spectrum for PLA polymer subjected to control enzymes 6,7 and 67.

FIG. 19. Effect of various candidate enzymes on PET polymer for an incubation duration of 1 week compared against control.

FIG. 20. Effect of various candidate enzymes on PET polymer for an incubation duration of 2 weeks compared against control.

FIG. 21. Effect of various candidate enzymes on PLA polymer for an incubation duration of 1 week compared against control.

FIG. 22. Effect of various candidate enzymes on PLA polymer for an incubation duration of 2 weeks compared against control.

FIG. 23. Effect of various candidate enzymes on LDPE polymer for an incubation duration of 1 week compared against control.

FIG. 24. Effect of various candidate enzymes on LDPE polymer for an incubation duration of 2 weeks compared against control.

FIG. 25. Effect of various candidate enzymes on HDPE polymer for an incubation duration of 1 week compared against control.

FIG. 26. Effect of various candidate enzymes on HDPE polymer for an incubation duration of 2 weeks compared against control study.

FIG. 27. Three-dimensional structure model of XP_026758376.1 enzyme predicted by alphaFold2 showing the position of the full catalytic triad at S319, D344 and H386.

FIG. 28A-28D. Structure analysis of G. mellonella enzyme XP-026764270.1 compared to Ideonella sakaiensis PETase (IsPETase).

FIG. 29A-29F. Structure analysis of G. mellonella enzyme XP-026762525.1 compared to Ideonella sakaiensis PETase (IsPETase).

FIG. 30: The chemical structure and the corresponding peaks for the LDPE degradation products exclusively identified by GC-MS in samples treated with wax moth lipase for 72 h compared to control.

FIG. 31: The chemical structure and the respective peaks for the degradation products identified in high peak areas in LDPE sample treated with wax moth lipase for 72 h compared to control.

FIG. 32: The chemical structure and the respective peaks for the degradation products identified in high peak areas in LDPE sample treated with PETase for 72 h compared to control.

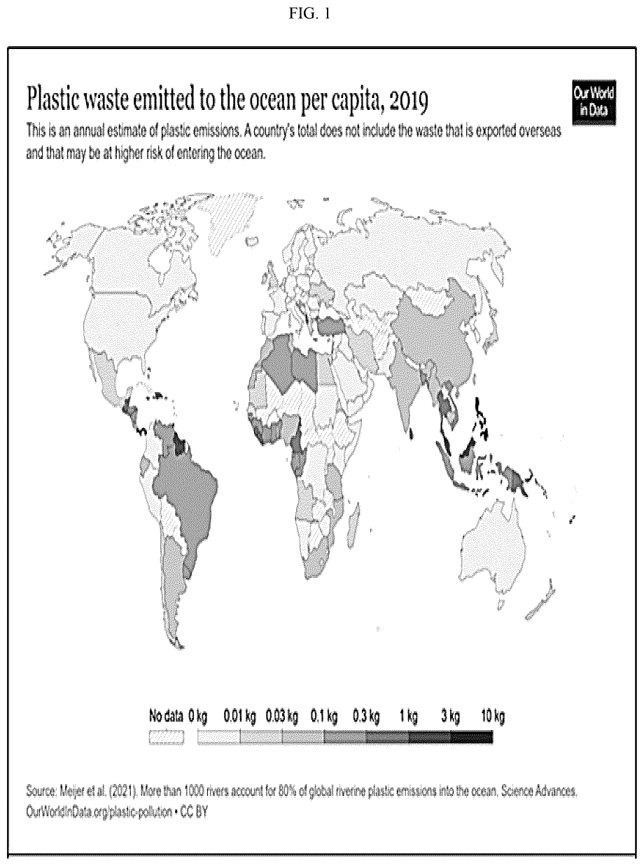

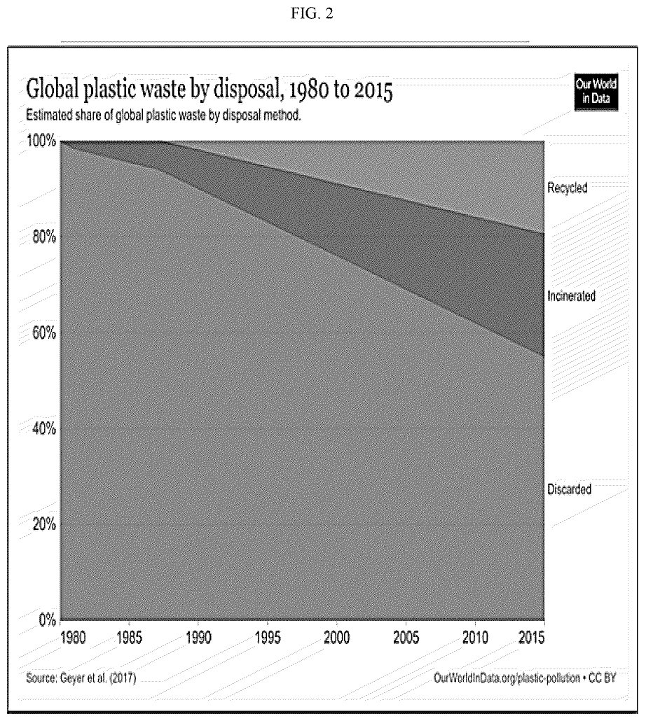

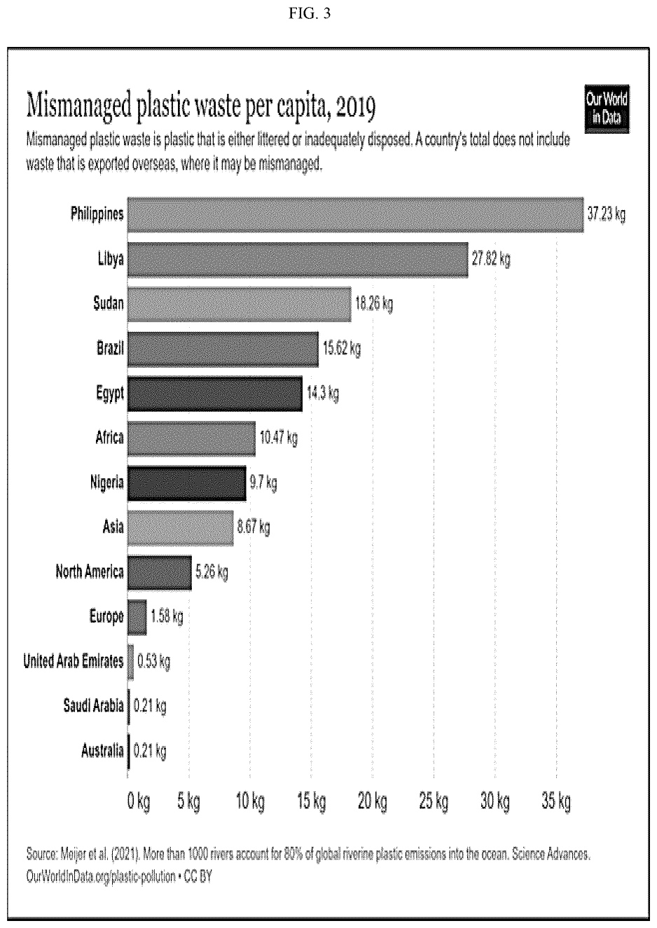

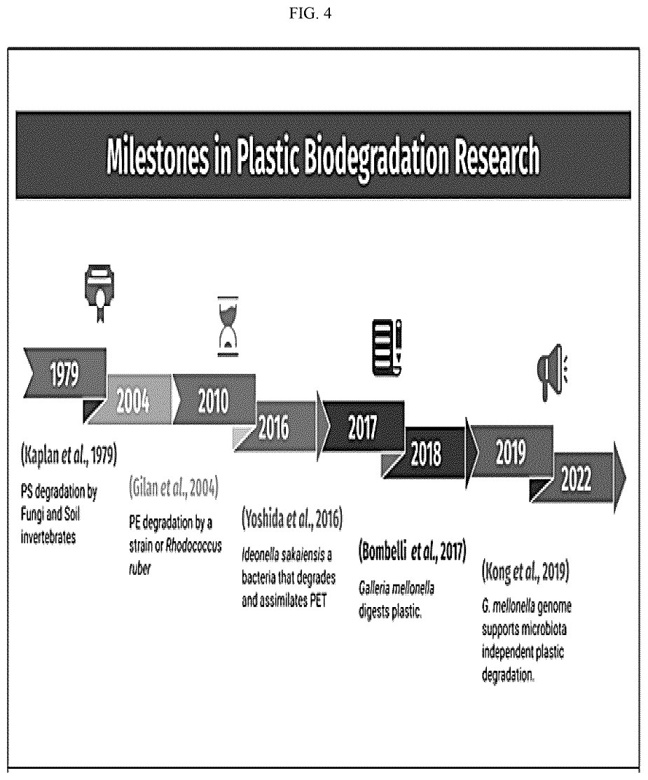

### DETAILED DESCRIPTION OF THE INVENTION

In addition to the brief description of the invention above, other embodiments of the invention include, but are not limited to, those described below.

One embodiment of the invention is directed to a method for degrading plastic with one or more enzymes encoded by the genome of the order Lepidoptera for a time and under conditions suitable for degrading the plastic. In some embodiments, the one or more enzymes are enzymatically active fragments, motifs, domains, or regions of the enzymes encoded by genes in the Lepidoptera genome. In other embodiments, the one or more enzymes are variants of the enzymes encoded by the Lepidoptera genome, such as variants having at least 60, 65, 70, 75, 80, 85, 90, 95, 99, <100% sequence identity or similarity thereto. The enzymes may be in free or soluble form, in a mixture or composition with other active agents or carriers, or may be bound to a substrate, such as chromatography beads, glass, or plastics. It may be applied to or incorporated into a plastic material or formulated into a self-degrading plastic.

The plastic may be part of an industrial, military, commercial, or consumer product, such as a plastic container, beverage bottle, wrapper, packaging, or sheet, or in a ground or pulverized form of such as in chunks, pellets, or powder. It may be a disposable plastic material. It may be part of an abandoned building or vehicle, waste dump, construction site, commercial litter, or part of accumulated environmental wastes, including riparian or oceanic waste plastics. In one embodiment, the plastics are in the form of microplastics which may be in a person's body, food, cosmetics, or other products ingested, inhaled, applied, or consumed.

In some embodiments, a plastic will be pretreated, concurrently treated, or surface-treated to make it more susceptible to degradation by the enzymes disclosed herein. For example, it may be chemically pretreated chemically with a strong acid or base to modify the surface or introduce surface defects that increases its exposure or susceptibility further degradation by the enzymes disclosed herein. It may be physically pre-treated to modify its surface or size, for example, by mechanical grinding, shredding, or milling into smaller chunks, granules, particles, or powder which increase surface area and exposure to the enzymes disclosed herein. or >100° C.), ultraviolet pretreatment, ozonation, gamma irradiation or mechanical sheering.

Another pretreatment comprises contacting the plastic with natural or artificial radiation, such as sunlight, UV, gamma irradiation, infrared/heat, or with natural weathering conditions. In some embodiments, it may be pretreated with plasma or ion bombardment to modify its surface or increase surface energy to make the plastic more degradable by the enzymes disclosed herein. It may also be pre-treated or concurrently treated with another biological agent, such as a different plastic degrading enzyme or by fungi, yeast or bacteria producing plastic degrading enzymes or cofactors for enzymatic degradation of plastic.

The method may comprise contacting the plastic with plastic-degrading enzymes that comprise, consist essentially of, or that consist of, those expressed by the genome of the order Lepidoptera, optionally in combination with other proteins, enzymes, or biomaterials produced by Lepidoptera or produced by the microbiome carried by Lepidoptera, such as enzymes produced by gut bacteria, yeast, or fungi in the guts of Lepidoptera larva; see e.g., Table 1.

In another embodiment, the plastic comprises low density polyethylene (LDPE) or high density polyethylene (HDPE). It may also comprise polyethylene terephthalate (PET), polylactic acid (PLA), mono(2-hydroxyethyl) terephthalate (MHET), polypropylene (PP), polystyrene (PS) or polyvinyl chloride (PVC).

In some embodiments, the one or more plastic degrading enzymes are encoded by the genome of, and expressed by, members of the family Pyralidae which is family of insects in the order Lepidoptera including snout and pyralid moths. In other embodiments, the one or more plastic degrading enzymes are encoded by the genome of and expressed by members of the genus Galleria which is a genus within the family Pyralidae that includes the greater and lesser wax moths the larva of which feed on beeswax. In another embodiment, the one or more plastic degrading enzymes are encoded by the genome and expressed by members of the species Galleria mellonella or greater wax moths.

The method disclosed herein is practiced with plastic degrading enzymes encoded by Lepidoptera. In some embodiments of this method the one or more plastic degrading enzymes are identified by XP_026749410.1, XP_026762525.1, XP_026758376.1, XP_026764270.1, and XP_026756911.1. The sequence information provided by the above-mentioned accession numbers (and by the other accession numbers described herein) is specifically incorporated by reference. Also, the functional or immunogenic fragments, motifs, domains, regions, or variants of the sequences herein identified by accession number is specifically incorporated by reference, including the sequences per se, enzymology, metabolic, source and other related information. Such information is available at hypertext transfer protocol secure://www.ncbi.nlm.nih.gov/protein (last accessed Jun. 19, 2024) which is incorporated by reference for all purposes.

Sequences include those described or identified by the following accession numbers: XP_026749410.1 describing a serine hydrolase like protein isoform X2 [Galleria mellonella]; XP_026762525.1 describing an acyl-protein thioesterase 1 [Galleria mellonella]; XP_026758376.1 describing phosphatidylserine lipaseABHD16A [Galleria mellonella]; XP_026764270.1 describing S-formylglutathione hydrolase isoform X2 [Galleria mellonella]; XP_026756911.1. describing abhydrolase domain-containing protein 2 [Galleria mellonella]. Additional sequences from Galleria mellonella are disclosed infra. All these sequences are described by and incorporated by reference to the corresponding accession numbers

In other embodiments, the plastic degrading enzymes used in the method disclosed herein include a PFAM motif that comprises PF00561 (alpha/beta hydrolase fold), PF12697 (alpha/beta hydrolase family), PF05057 & Putative serine esterase (DUF676), PF07819 (PGAP1-like protein), PF12695 (alpha/beta hydrolase family, serine aminopeptidase), PF00326, (prolyl oligopeptidase family), PF12146 (serine aminopeptidase, S33), PF05448 (Acetyl xylan esterase, AXE1) or PF01083 (Cutinase) or that comprises fragments, motifs, domains, regions, or variants thereof.

FIG. 5 shows the degradation steps and mechanisms of Ideonella sakaiensis that could be shared with, or analogous to those in Galleria mellonella. Kohei Oda of Kyoto Institute of Technology and Kenji Miyamoto of Keio University made the first identification of Ideonella sakaiensis in 2016. This strain can hydrolyze PET and the intermediate of the process, mono(2-hydroxyethyl) terephthalic acid (MHET), when cultivated on PET. PET could then be effectively converted enzymatically into the two ecologically safe monomers terephthalic acid and ethylene glycol using both enzymes. The I. sakaiensis PETase works by highly specifically hydrolyzing the ester bonds found in PET. A MHET hydrolase enzyme, also known as MHETase, that is lipid-anchored toward the cell's outer membrane breaks down the resultant MHET into constituent monomeric components.

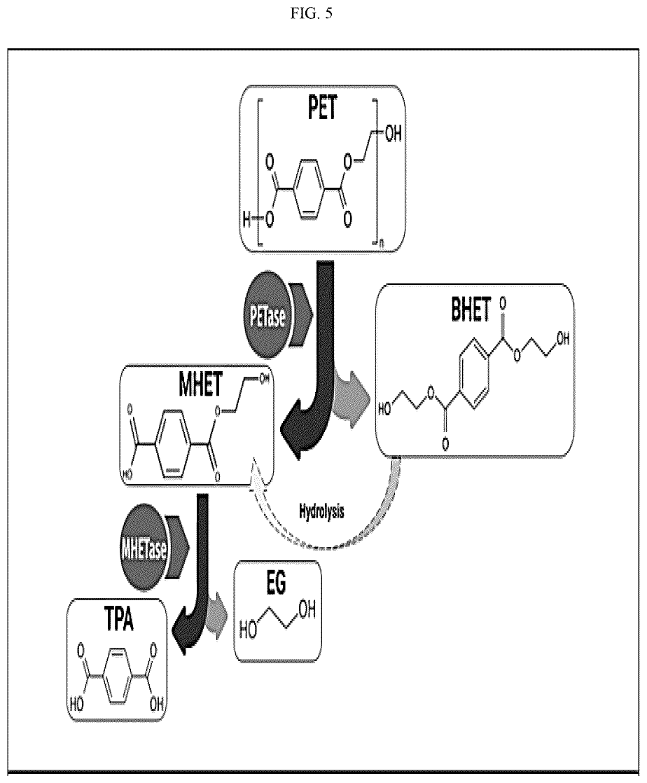

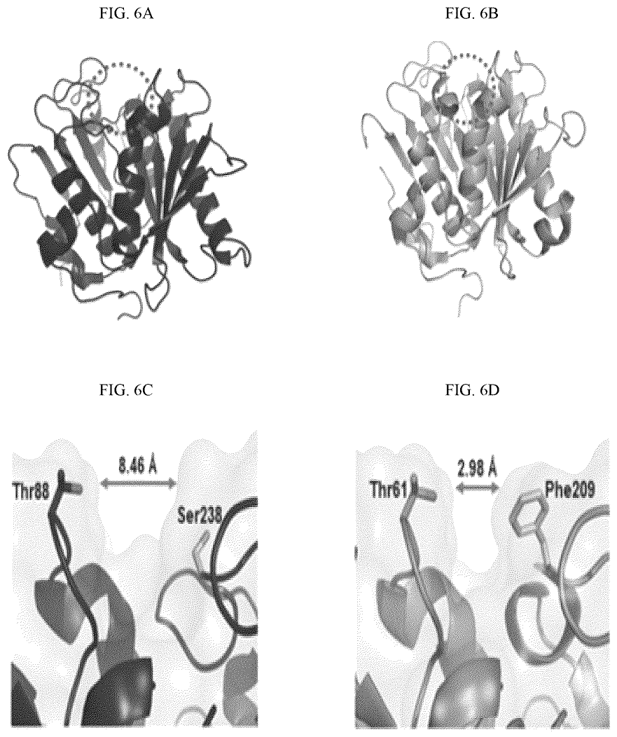

In some embodiments, the one or more enzymes comprise an enzymatically active site comprising a triad of discontinuous amino acid residues comprising 1, 2 or 3 of, or consisting of Ser, His and Asp. In some embodiments, this catalytic triad may be substantially aligned with a triad of amino acid residues consisting of Ser160, His237 and Asp206 in the poly(ethylene terephthalate)ase (PETase) of Ideonella sakaiensis accession number GAP38373. Alignment of this triad in the enzymes disclosed herein may also be made by reference to Ser, His, Asp triad found in some serine protease enzymes including chymotrypsin, trypsin, and subtilisin. FIG. 6 shows sequence and active site similarities between Thermobifida fusca cutinase named TfCut2 (PDB ID: 4CG1) that shares high sequence similarity with PETase (52% sequence identity). The active site for plastic degradation in PETase is named the catalytic triad and consists of Ser160, Asp206 and His237. These and other corresponding residues in the plastic-degrading enzymes disclosed herein may be structurally modified, for example, by addition, substitution or deletion of residues, to increase the efficiency of plastic degradation in the enzymes disclosed herein.

FIG. 6 describes structural differences between PETase and TfCut2 enzymes. These include a description of in FIG. 6A PETase structure as seen in a graphical representation at 0.92 Å given by PDB ID number 6EQE (incorporated by reference). The top-facing active site is marked with a dashed circle. In FIG. 6B a comparative structure given by PDB ID: 4CG1 (incorporated by reference) from T. fusca TfCut 2. FIG. 6C represents a view of the PETase active site cleft where the region is indicated by a dash circle (see FIG. 6A). Between Thr88 and Ser238 is where the cleft's distance is depicted. FIG. 6D shows for comparison, the diseases between Thr61 and Phe209 in the active site's narrower cleft of TfCut2 cutinase as illustrated in a relevant location, see Austin, et al., 2018. The numbering of amino acid residues in fragments or analogs of these proteins may optionally correspond to that given in FIG. 6.

In certain embodiments, the one or more plastic degrading enzymes exert carboxylesterase activity and/or lipase activity and/or hydrolase activity. These enzymes may also be active on other materials such as triglycerides, carbohydrates, or proteins.

In some embodiments of the methods disclosed herein the one or more plastic-degrading enzymes is isolated from a cell in vitro or from a cell-free system. Such as system may employ cell lysates or extracts containing the necessary components for protein synthesis including ribosomes, amino acids, tRNA, mRNA and other cofactors.

In other embodiments, the enzymes may be expressed in bacteria or another prokaryote, or in yeast, fungi, insects, or another eukaryote. For example, a plastic degrading enzyme disclosed herein may be expressed or over-expressed (e.g., by genetic engineering) by an insect of order Lepidoptera or by larva thereof. In one embodiment, the one or more plastic-degrading enzymes are expressed in Lepidoptera larvae which have been engineered to express said plastic-degrading enzymes in higher (or lower) amounts or express fragments, domains, or variants of said enzymes having a higher (or lower) specific enzymatic activity for degrading plastic, a higher (or lower) thermostability, higher (or lower) enzymatic stability to acidic or basic pH or higher (or lower) stability to environmental conditions. Such an expressed enzyme may comprise a fragment, motif, or region of an enzyme disclosed herein or a variant thereof as disclosed herein.

In some embodiments of the methods disclosed herein the contacting between enzyme and plastic occurs at an acid pH ranging from pH<3, 4, 5, 6, or 7 and/or at a temperature ranging from <25, 25, 30, 35, 40, 45, 50, 55, 60, or >60 degrees Celsius. In another embodiment, the contacting occurs at a basic pH ranging from >7, 8, 9, 10, or >10. These ranges include all intermediate values and subranges.

As mentioned above, in some embodiments, the methods of degrading plastic described herein further comprise physically, chemically, or biologically degrading the plastic during or prior to contacting it with the one or more enzymes.

Another aspect of the invention is directed to a non-naturally occurring, engineered enzyme that comprises an amino acid sequence that is at least 60, 65, 70, 75, 80, 85, 90, 95, 99, <100% identical or similar to an enzyme expressed in the order Lepidoptera that degrades plastic, or an enzymatically active fragment or domain thereof.

Sequence Identity or Similarity. BLASTN may be used to identify a polynucleotide sequence having at least 60%, 65%, 70%, 75%, 80%, 85%, 87.5%, 90%, 92.5%, 95%, 97.5%, 98%, 99% or <100% sequence identity to a reference polynucleotide such as a polynucleotide encoding a Lepidoptera plastic degrading enzyme. General representative algorithm (default) parameters for BLASTN include Expect threshold of 0.05 (expected number of chance matches in a random model), word size of 28 (length of the seed the initiates an alignment), Max mismatches in a query range 0, Scoring parameters: March/Mismatch 1, -2 (reward and penalty for matching and mismatching bases), Gap Costs: linear (cost to created and extend a gap in an alignment); Filter: low complexity regions; Mask: mask for lookup table only. In case of ambiguity, these default BLASTN algorithm parameters are used.

Another representative BLASTN setting modified to find highly similar sequences uses an Expect Threshold of 10 and a Wordsize of 28, max matches in query range of 0, match/mismatch scores of 1/-2, and linear gap cost. Low complexity regions may be filtered or masked. Default settings of a Standard Nucleotide BLAST are described by and incorporated by reference to <hypertext transfer protocol secure://blast.ncbi.nlm.nih.gov/Blast.cgi?PROGRAM-blastn&PAGE_TYPE=BlastSearch&LINK_LOC=blasthome> (last accessed Apr. 26, 2023).

BLASTP can be used to identify an amino acid sequence having at least 60%, 65%, 70%, 75%, 80%, 85%, 87.5%, 90%, 92.5%, 95%, 97.5%, 98%, 99% or <100% sequence identity, or similarity to a reference amino acid, such as amino acid sequence for a Lepidoptera plastic degrading enzyme, using a similarity matrix such as BLOSUM45, BLOSUM62 or BLOSUM80 where BLOSUM45 can be used for closely related sequences, BLOSUM62 for midrange sequences, and BLOSUM80 for more distantly related sequences. Unless otherwise indicated a similarity score will be based on use of BLOSUM62. When BLASTP is used, the percent similarity is based on the BLASTP positives score and the percent sequence identity is based on the BLASTP identities score. BLASTP “Identities” shows the number and fraction of total residues in the high scoring sequence pairs which are identical; and BLASTP “Positives” shows the number and fraction of residues for which the alignment scores have positive values and which are similar to each other. Amino acid sequences having these degrees of identity or similarity or any intermediate degree of identity or similarity to the amino acid sequences disclosed herein are contemplated and encompassed by this disclosure. General representative algorithm (default) parameters include Expect threshold of 0.05 (expected number of chance matches in a random model), word size of 5 (length of the seed the initiates an alignment), Max mismatches in a query range 0, Matrix: BLOSUM62, Gap Costs Existence: 11 Extension: 1 (cost to created and extend a gap in an alignment), and Compositional Adjustments: conditional compositional score matrix adjustment. In case of ambiguity, the default BLASTP algorithm parameters are used.

Another representative BLASTP setting that uses an Expect Threshold of 10, a Word Size of 3, BLOSUM 62 as a matrix, and Gap Penalty of 11 (Existence) and 1 (Extension) and a conditional compositional score matrix adjustment. Other default settings for BLASTP are described by and incorporated by reference to the disclosure available at: <hypertext transfer protocol secure://blast.ncbi.nlm.nih.gov/Blast.cgi?PROGRAM=blastp&PAGE_TYPE=BlastSearch&LINK_LOC=blasthome> (last accessed Apr. 26, 2023).

This engineered enzyme may digest or degrade low density polyethylene (LDPE) or high density polyethylene (HDPE), polyethylene terephthalate (PET), polylactic acid (PLA), mono(2-hydroxyethyl) terephthalate (MHET), polypropylene (PP), polystyrene (PS) or polyvinylchloride (PVC).

In one embodiment, the engineered enzyme comprises, consists of, or is derived from a sequence <100% identical or similar to XP_026749410.1, XP_026762525.1, XP_026758376.1, XP_026764270.1, and XP_026756911.1.

In another embodiment, the engineered enzyme comprises a PFAM motif that is PF00561 (alpha/beta hydrolase fold), PF12697 (alpha/beta hydrolase family), PF05057 & Putative serine esterase (DUF676), PF07819 (PGAP1-like protein), PF12695 (alpha/beta hydrolase family, serine aminopeptidase), PF00326, (prolyl oligopeptidase family), PF12146 (serine aminopeptidase, S33), PF05448 (Acetyl xylan esterase, AXE1) or PF01083 (Cutinase).

In another embodiment, the engineered enzyme comprises an active site comprising a triad of discontinuous amino acid residues consisting of Ser, His and Asp or it comprises a catalytic triad of amino acid residues consisting of Ser, His and Asp, substantially as aligned with a triad of amino acid residues consisting of Ser160, His237 and Asp206 in the poly(ethylene terephthalate)ase (PETase) of Ideonella sakaiensis accession number GAP38373.

An engineered enzyme may have carboxylesterase activity, lipase activity and/or hydrolase activity which may be increased. The engineered enzyme may have a higher specific activity or may have been engineered to alter its physical, chemical, or biological properties toward degrading plastic as compared to an unmodified parent enzyme. In some embodiments, the engineered enzyme has a higher specific activity than the corresponding enzyme expressed in the order Lepidoptera. In other embodiments, the engineered enzyme has a higher thermostability, higher enzymatic stability to acidic or basic pH, or higher stability to environmental conditions than the corresponding enzyme expressed in the order Lepidoptera. In other embodiments, the engineered enzyme may have one or more of these properties lowered, for example, to control the rate of plastic degradation in certain applications or extend the useful lifetime of a self-degrading plastic incorporating a variant enzyme, but after its use, to permit it to slowly degrade.

Another embodiment of the invention involves a composition comprising a plastic-degrading enzyme expressed by the order Lepidoptera or an engineered enzyme that has an amino acid sequence that is at least 60, 65, 70, 75, 80, 85, 90, 95, 99, <100% identical or similar to an enzyme expressed by the genome of the order Lepidoptera and at least one carrier or enzymatic stabilizer. In such a composition the plastic-degrading enzymes may comprise, consist essentially of, or consist of, those expressed by the genome of the order Lepidoptera. Alternatively, other enzymes from bacteria, fungi, or other sources may be included in the composition. The composition may comprise water and conventional buffers or ingredients including phosphate buffer, Tris-HCl buffer, HEPES buffer, MES buffer, or citrate buffer. Other ingredients such as Mg or Ca may be included.

Another embodiment of the invention involves a cell or organism transformed with, and which expresses, a plastic-degrading enzyme expressed by the order Lepidoptera or which expresses an engineered enzyme that has an amino acid sequence that is at least 60, 65, 70, 75, 80, 85, 90, 95, 99, <100% identical to an enzyme expressed in the order Lepidoptera. The cell or microorganism may be a prokaryote such as a Gram positive or Gram negative bacterium, or cukaryote such as a yeast, fungi, plant, insect, insect larva or other eukaryote. An insect or insect larva may be a member of Lepidoptera, Pyralidae, or Galleria. In one embodiment an enzyme or variant enzyme disclosed herein may be expressed by gut bacteria of an organism, such as by those in the mammalian, avian, or piscean (fish) guts, for example, to degrade metabolized microplastics.

A composition containing cells which express the plastic degrading enzymes may include nutrients for the cells including a carbon source. Animals expressing the plastic-degrading enzymes and that form part of a plastic degrading composition may include conventional feeds, including for wax moths, beeswax.

A further embodiment of the invention is directed to animal or plant comprising, or encoding and expressing, one or more plastic-degrading enzymes expressed by the genome of Lepidoptera.

Another embodiment of the invention is directed to a cell or organism that is Lepidoptera, Pyralidae, or Galleria, wherein expression of a plastic degrading enzyme has been knocked out. Such a knockout mutation can be employed to further determine the function and a specific enzyme in Lepidoptera or its larva or study the effects of the knockout on an ability or these organisms to feed on beeswax or on plastics. It can also be used to evaluate the possible interactions between enzymes encoded by Lepidoptera on plastic degradation. It could also be used as a control for comparison with Lepidoptera that has not been knocked out.

Another aspect of the invention is directed to a protein expression system such as that mentioned above that uses cell-free protein expression technology to express the plastic-degrading enzymes disclosed herein.

The following non-limiting examples explain how plastic degrading enzymes in Galleria were identified, characterized, and evaluated for their abilities to degrade plastics.

### EXAMPLES

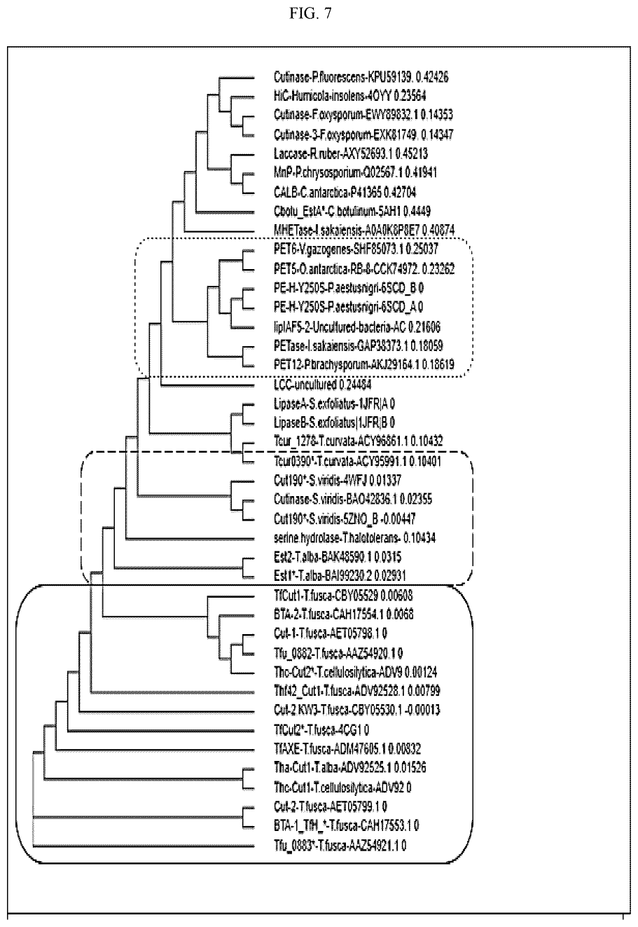

The following examples illustrate how the inventors identified genes encoding putative plastic degrading enzyme from Lepidoptera by detailed bioinformatic analysis of sequences including those appearing in the Appendix. Using the resulting bioinformatic data the inventors selected several genes for further investigation of the enzymatic activities of the proteins they encode. These genes include XP_026749410.1, XP_026762525.1, XP_026758376.1, XP_026764270.1, and XP_026756911.1. Host cells were transformed with these genes to express the putative enzymes they encode. These studies and their results appear in Example 1 and in FIGS. 7-13. The putative enzymes encoded by these genes were then evaluated for their abilities to degrade plastic by Scanning Electron Microscopy (SEM) and by Fourier Transform Infrared analysis (FTIR). The results of these studies appear in Examples 2 and 3 and in FIGS. 14-26.

### Example 1

### Bioinformatic Identification of Candidate Enzymes from G. mellonella

Multiple sequence alignment and phylogenetic analysis. All sources of protein FASTA sequences were obtained from NCBI protein databases RefSeq: NC_028532.1 and Lipases 1,3 and Carboxylases protein sequences PDB IDs were added accordingly citing their relevant publications. Full amino acids FASTA sequences are available in and incorporated by reference to the Appendix in the provisional priority document and are described by or incorporated by reference to their accession numbers. For example, the sequences described by accession numbers 1-38 in Table 1 are described by or incorporated by reference to these 38 accession numbers. All 38 microbial functionally characterized enzymes were obtained from a manual literature review that was the outcome of this research and was confirmed with the Plastic Database. Full names and NCBI protein accession numbers of the functionally characterized enzymes can be found in Table. 1, full FASTA sequences for the amino acids can be found in and incorporated by reference to the Appendix of the provisional priority document, see also Gambarini et al., 2022.

TABLE 1
Various Plastic degrading enzymes and their respective Organisms. Sorted based on Protein Families.

| | Protein | | | NCBI Protein |
|---|---|---|---|---|
| No | Family | Description | Organism | Accession No. |
| 1 | Cutinase | HiC | Humicola insolens | 4OYY_L |
| 2 | | TfCut2* | T. fusca | 4CG1_A |
| 3 | | TfCut1 | T. fusca | CBY05529 |
| 4 | | cut-2.KW3 | T. fusca | CBY05530 |
| 5 | | Cut-1 | T. fusca | AET05798 |
| 6 | | Cut-2 | T. fusca | AET05799 |
| 7 | | Thc-Cut1 | T. cellulosilytica | ADV92526 |
| 8 | | Thc-Cut2* | T. cellulosilytica | ADV92527 |
| 9 | | Cutinase | Saccharanonopsora viridis | BAO42836.1 |
| 10 | | Cut 190* | Saccharanonopsora viridis | 4WFJ_A 5ZNO_B |
| 11 | | Cutinase | Pseudomonas fluorescens | KPU59139.1 |
| 12 | | Cutinase | Fusarium oxysporum | EWY89832.1 |
| 13 | | FOQG_13916 | Fusarium oxysporum | EXK81749 |
| 14 | | LCC | Uncultured bacteria | AEV21261 |
| 15 | | PET6/SAMN02745781_03338 | Vibrio gazogenes | SHF85073 |
| 16 | Alpha/Beta | Est2 | Thermobifida alba | BAK48590 |
| 17 | Hydrolase | Est1* | Thermobifida alba | BAI99230 |
| 18 | | Polyester hydrolase PE-H Y250S | Pseudomonas aestusnigri | 6SCD_B 6SCD_A |
| 19 | | Thf42_Cut1 | T. fusca | ADV92528 |
| 20 | | Tha-Cut 1 | Thermobifida alba | ADV92525 |
| 21 | | TfAXE | T. fusca | ADM47605 |
| 22 | | Tcur_1278 | Thermomonospora curvata | ACY96861 |
| 23 | | Tcur0390* | Thermomonospora curvata | ACY95991 |
| 24 | | Cbotu_EstA* | Clostridium botulinum | 5AH1_A |
| 25 | | BTA-hydrolase 1/BTA-1 (TfH)* | T. fusca | CAH17553.1 |
| 26 | | BTA-2 | T. fusca | CAH17554.1 |
| 27 | | PETase (Bacterial Lipase) | Ideonella sakaiensis | GAP38373 |
| 28 | | PET 2 lipIAF5-2 | Uncultured bacteria | ACC95208 |
| 29 | | PET5 lipA OLEAN_C07960 | Oleispira antarctica RB-8 | CCK74972 |
| 30 | | PET12 AAW51_2473 | Polyangium brachysporum | AKJ29164 |
| 31 | | Lipase | Streptomyces exfoliatus | 1JFR_A 1JFR_B |
| 32 | | Tfu_0882 | T. fusca | AAZ549α20 |
| 33 | | Tfu_0883* | T. fusca | AAZ54921 |
| 34 | | lipase B (CALB) | Candida antarctica | P41365 |
| 35 | | Serine hydrolase | Thermobifida halotolerans | AFA45122 |
| 36 | Peroxidase | (MnP) manganese peroxidase | Phanerochaete chrysosporium | Q02567.1 |
| 37 | Tannase | MHETase-ISF6_0224 | Ideonella sakaiensis | A0A0K8P8E7 |
| 38 | Laccase | Laccase | Rhodococcus ruber | AXY52693 |

*Higher efficiency/affinity towards more plastic polymers compared against PETase.

Then, MUSCLE and CLUSTAL Omega by EMBL-EBI were used for (Edgar, 2004) for constructing the multiple sequence alignments of the candidate protein families against functionally characterized proteins and various proteins from G. mellonella to investigate the evolution of this ability. Then, the low-quality alignments were filtered using trim AI (Capella-Gutierrez et al., 2009) via the option of ‘gappyout’. Then using simple phylogeny tool by EMBL-EBI to construct the relevant phylogenetic trees (Madeira et al., 2022), the tree files were then downloaded. The iTol server was then used for graphical representation of the phylogenetic trees; see Letunic & Bork, 2021.

Basic local Alignment and motif analysis. Using BLASTp (Altschul et al., 1990) to investigate the sequence similarity between closely clustered candidate proteins and Motif Search using KEGG-MOTIF (Kanchisa et al., 2017) for correlating the shared motifs between closely clustered candidate G. mellonella proteins to functionally characterized proteins and their corresponding annotated function. Motif analysis also took into consideration the literature review and SAR by the relevant publications and especially for the catalytic triad as the hallmark for plastic degradation of PETase (Kitadokoro et al., 2019).

Generation of target genes cDNA was performed according to the protocol of Austin, et al., 2018. Candidate genes' sequences were retrieved from G. mellonella genome assembly RefSeq: NC_028532.1, full amino acid sequence data can be found in and is incorporated by reference to the Appendix in the provisional priority document. Positive control PETase and MHETase FASTA sequences obtained from PDB ID: 6EQE & 6QGB respectively by (Yoshida et al., 2016). Rare codon analysis and omission was conducted using ATGme server and Synbio Technologies servers; all rare codons were removed and replaced to maintain a codon frequency >10% for all codons used, (Daniel et al., 2015). Constructs established via expression plasmids as the bacterial vector for the inducible expression of our proteins of interest, cloning sites and vector types were generated as per Table. 2, full sequence data can be found in the Appendix incorporated by reference to the provisional priority application, Chapter 7 below (SynBio), synthetic nucleotide sequences obtained from (Synbio Technologies, NJ, USA) antibiotics selected were alternating so as to limit the possibility of cross contaminating the samples, constructs received as 2 micrograms lyophilized plasmids. The sequences described by Gene IDs given in Table 2 are specifically incorporated by reference. The restriction cloning sites in Table 2 are well known in the art.

TABLE 2
Synthetic Constructs and their relevant
plasmid types and cloning sites

| No | Type | Gene ID | Vector Name | Cloning Site |
|---|---|---|---|---|
| 1 | Candidate | XP_026749410.1 | PET28a(+), | BamHI/EcoRI |
| | | | Kan | |
| 2 | Candidate | XP_026762525.1 | PET21a(+), | BamHI/EcoRI |
| | | | Amp | |
| 3 | Candidate | XP_026758376.1 | PET24a(+), | EcoRI/HindIII |
| | | | Kan | |
| 4 | Candidate | XP_026764270.1 | PET24a(+), | BamHI/EcoRI |
| | | | Kan | |
| 5 | Candidate | XP_026756911.1 | PET21a(+), | BamHI/EcoRI |
| | | | Amp | |
| 6 | +ve Control | PETase GAP38373 | PET28a(+), | BamHI/HindIII |
| | | | Kan | |
| 7 | +ve Control | MHETase-ISF6_0224 | PET21a(+), | BamHI/HindIII |
| | | | Amp | |

Transformation and protein expression was done according to (Shi et al., 2021) this protocol was repeated for every construct and 3 replicates were present for proper laboratory practice, with system optimization changes as follows, reconstitution of the lyophilized plasmids were done to 2 micrograms in 50 microlitres of autoclaved water to reach a final conc of 40 ng in microliters. Then, for the transformation, 3 microlitres of above reconstitute were added to 100 microlitre of electrocompetent BL21 cells, followed by immediate incubation on Ice for 30 minutes, then heat shock for 30 seconds at 42° C. without shaking followed by Immediate transfer to ice then we added 250 micL autoclaved room temperature LB broth to the tubes, incubated at 37 celcius for 1 hour with shaking at 300 RPM. 100 microliters were then spread from the tubes on LB plates containing the relevant antibiotic according to Table.2 concentrations of antibiotics stock solutions used were Kan(50 mg/ml) and Amp(100 mg/ml), 50 microlitre of the stock solutions were added to the plates before pouring and avoiding vigorous shaking. plates were incubated at 37 degrees Celsius overnight (16 Hrs). Successful transformation of all samples and controls was done as evidenced by white colonies isolated from the transformed plates.

Glycerol stocks of the transformed bacteria were established according to (Sivashanmugam et al., 2009) with system optimization adjustments as follows, adding 500 μL of the overnight culture to 500 μL of 50% glycerol in a 2 mL screw top tube or cryovial and with gentle mixing stocks are then saved in −80° C. freezers for future uses. For expression, single colonies from transformation was then inoculated into a culture of Luria Broth (LB) media containing 100 μg/ml ampicillin or Kanamycin 50 μg/ml according to their relevant plasmid and experimental design Table.2, cultures are then grown at 37° C. overnight. 100 fold dilution of starter culture was then inoculated into LB medium containing 100 μg/mL ampicillin or Kanamycin 50 μg/ml according to their relevant plasmid and experimental design Table.2, kept at 37° C. until the OD: optical density measured at 600 nM reached 0.7±0.1. Protein expression was then stimulated by adding IPTG: isopropyl β-D-1-thiogalactopyranoside reaching a final concentration of 0.1 mM, kept overnight (16 Hrs) for induction. Cells were maintained at 20° C. for a duration of 18 to 24 hours after the IPTG induction, then centrifuged for harvesting, and stored at −80° C. (Knott et al., 2020).

Phylogenetic analysis and Multiple Sequence Alignment of functionally characterized enzymes. Building on the literature review and the work by (Kong et al., 2019), protein FASTA sequences for 38 functionally characterized enzymes were all seen to be segmented based on their sequence similarity to 5 main categories as in Table 1. Phylogenetic tree was established based on the multiple sequence alignments by MUSCLE and after trimming low quality alignments to understand the evolutionary relationship between the homologous sequences to understand the underlying similarity in their ability to degrade plastic polymers FIG. 7, sequences of the functionally characterized enzymes are in and incorporated by reference to the Appendix in the provisional priority application.

The results are surprisingly in line with the reports of (Austin et al., 2018) that states that PETase enzymes are evolved presumably from Cutinases like enzymes as in TfCut2 of T. fusca. The inventors observed that the cutinases were close to the root of the phylogenetic tree in general. What is interesting as well is the alignment of these results with the study of Joho et al., 2022 that showed through his study that PETase's evolution also passed through an ancestral serine hydrolase like protein, this matches our finding that serine hydrolase isolated from T. halotolerans was phylogenetically closer to the root and resembles a middle point between cutinases and PETase (Joho et al., 2022).

The inventors unexpectedly found that TfCut2 and cutinase groups maintained their structure and sequence and yet, they remained with higher affinity and wider variety of targets than PETase. While not being bound to any theory or explanation, this might be attributed to their thermal stability as reported by Magalhães et al., 2021 and could possibly explain why the affinity for PETase to degrade aliphatic esters is much lower than TfCut2. It is possible that PETase was highly evolved in a PET rich environment and was subject to selective pressure. It was isolated from one for the first time in 2016 (Yoshida et al., 2016). Thus, the inventors selected Group A & B from FIG. 7 to perform phylogenetic analysis compared with functionally characterized enzymes. To confirm these results, the inventors conducted confirmatory analysis using the full list of the functionally characterized enzymes in Table 1.

Each group was assigned according to their respective similarity to either Lipase or Carboxylase mode of actions and motifs. FIG. 7 describes a phylogenetic tree of 38 functionally characterized plastic degrading enzymes. The solid line shows early evolved ancestral enzymes with plastic degrading abilities. The dashed line shows functional group B selected for comparison with G. mellonella lipases. The * indicates a higher affinity towards a wide variety of plastic polymers degradation compared to PETase as the benchmark.

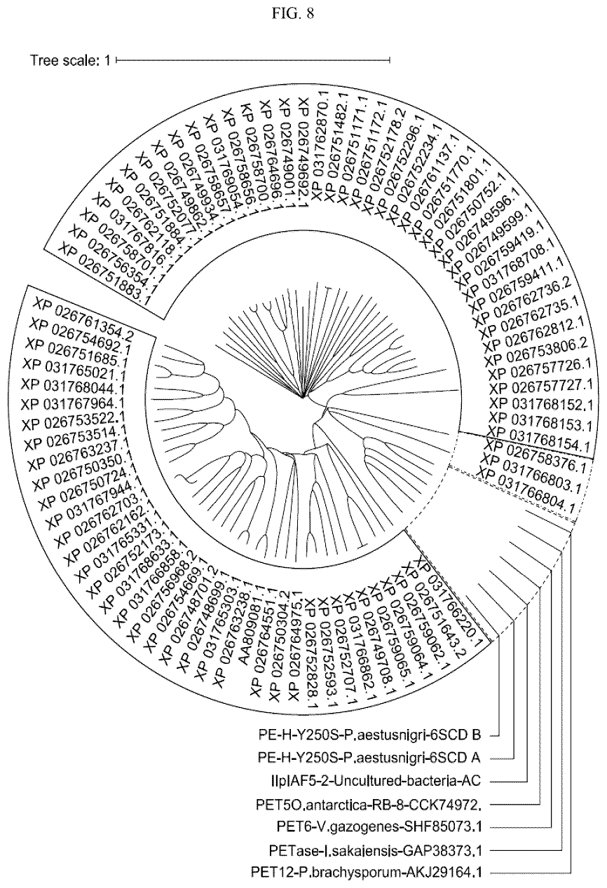

Phylogenetic analysis and Multiple Sequence Alignment of functionally characterized enzymes Vs Potential Wax Moth Enzymes. The selected representatives of the plastic degrading enzymes described above were functionally characterized. Aligned, trimmed and phylogenetic trees were developed with potential candidate families of enzymes from G. mellonella. FIG. 8 depicts a phylogenetic Tree between Functional Group A and G. mellonella lipases. Red highlight shows G. mellonella Lipases 1, 3 Family of Enzymes. Navy blue (dark, near 5 o'clock) highlight shows Group A of the functionally characterized enzymes. Teal (light near 4 o'clock) shows the potential candidates form Wax moth that are clustered near Group A.

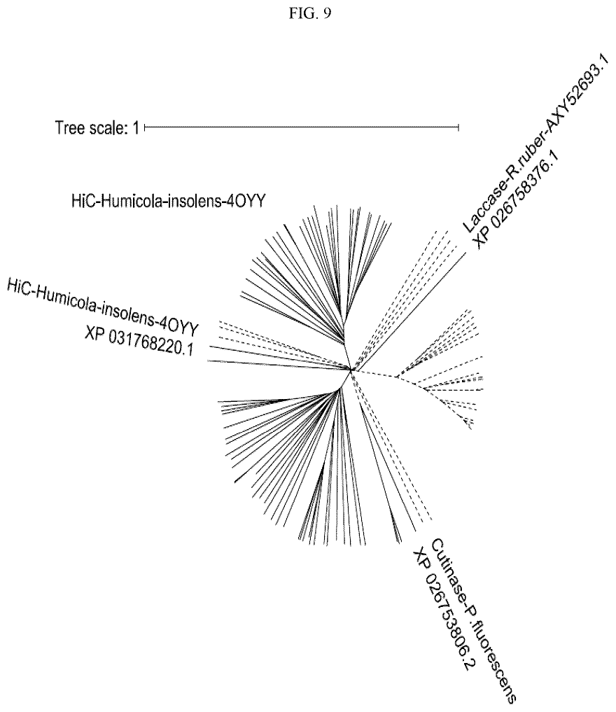

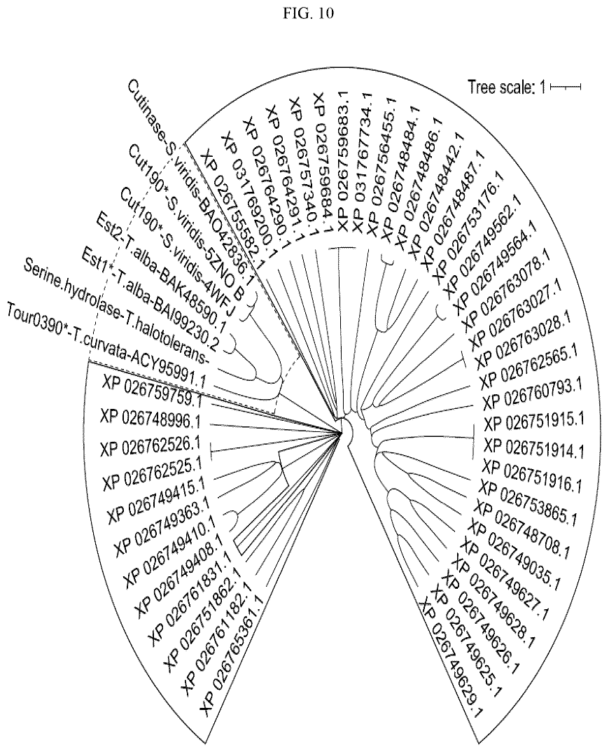

These families were: Lipases 1,3 (82 NCBI protein hits were found) FIG. 8, FIG. 9 and Carboxylesterase Enzyme Family FIG. 10 and FIG. 11 44 NCBI protein hits were found. FASTA sequences collected. Confirmatory trees were developed by comparing the full spectrum of functionally characterized 38 enzymes collected in Table 1 with both potential Wax moth Families separately. Selected potential candidates that showed concordance between the two phylogenetic trees one with the representative groups FIG. 8 and one with the full list as in Table 1 are shown in FIG. 9. Candidate enzymes were then selected from both Wax moth enzyme families based on their clustering with functionally characterized enzymes in both trees.

Three Lipase candidates were evident as being closely clustered right in a shared branch with functional Group A in FIG. 8, namely; XP_026758376.1, XP_031766804.1 and XP_031766803.1 (sequences described by each are incorporated by reference).

These findings were confirmed with the second tree with the full 38 functionally characterized enzymes in FIG. 9. It was quite surprising to see the Group A of functionally characterized microbial enzymes cluster right in the center of the G. mellonella Lipases, suggesting that a potential sequence and function similarity is evident. FIG. 9 describes unrooted Phylogenetic Tree of 38 Functionally Characterized Plastic Degrading Enzymes with Lipase (1,3) Enzyme Families from the Greater Wax moth. Navy blue (dark) branches belong to the functionally characterized microbial plastic degrading enzymes. Red (light) branches belong to the Candidate Lipases (1,3) Families from G. mellonella. Only adjacent Enzymes to the candidate Lipase are labeled with large font size.

Lipase Candidate XP_026758376.1 was even more surprising as it was shown to be phylogenetically located between two major branches of the functional 38 enzymes, noting that all of these enzymes are from microbial origin, while the wax moth belongs to a phylogenetically distant lepidoptera order. Thus, candidate XP_026758376.1 was selected as a potential plastic degrader from the Lipase group; see FIG. 9.

FIG. 10 describes phylogenetic tree of the carboxylesterase Family Enzymes of G. mellonella against Group B of the functionally characterized enzymes. Teal Color (dark, near 10 o'clock) shows functionally characterized plastic degraders (Group B). Spearmint Color (light) shows Carboxylesterase Family Enzymes.

When comparing Carboxylesterase family enzymes from G. mellonella, against Group B of functionally characterized plastic degrading enzymes, it was found that around 12 enzymes were phylogenetically closer to the plastic degrading enzyme Teur 0390 enzyme from T. curvata than they are to the rest of the carboxylesterase family of enzymes (Islam et al., 2019). These surprising observations are worthy of further investigation. While not being bound to any theory or explanation, they might be attributed to evolutionary pressure or even horizontal gene transfer as (Wybouw et al., 2016) studied the role of horizontal gene transfer in insects and that many of the insect's enzymes cannot be explained without such gene transfer. A confirmatory tree appears in FIG. 11.

FIG. 11 describes an unrooted phylogenetic tree for Carboxylesterase family enzymes of the Greater wax moth and 38 functionally characterized enzymes. Teal Color (dark, near 3-4, 9-10, 11-12 o'clock) shows functionally characterized plastic degraders. Spearmint Color (light) shows Carboxylesterase Family Enzymes. Only relevant candidates and their closely clustered functional enzymes are labeled.

Complete agreement between 12 candidates from FIG. 10 and FIG. 11 was found, clearly endorsing the selection relevancy for Group A and B and more importantly affirming the approach for selecting the candidate enzymes. Also, a surprisingly large number of Carboxylesterases from the greater wax moth seemed to be clustered near or within the functionally characterized groups. Consequently, we opted to proceed with local sequence alignment and further narrow down the number of 13 total candidates (12 Carboxylesterases and 1 lipase), while prospecting other enzymes that were not included in both groups in the process.

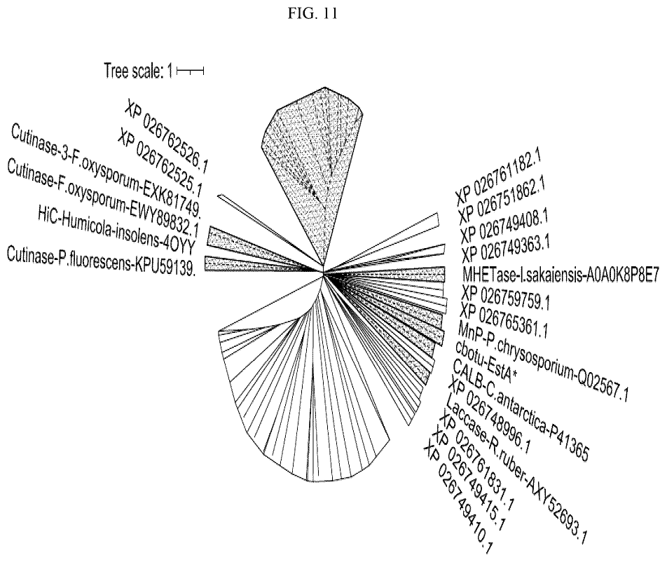

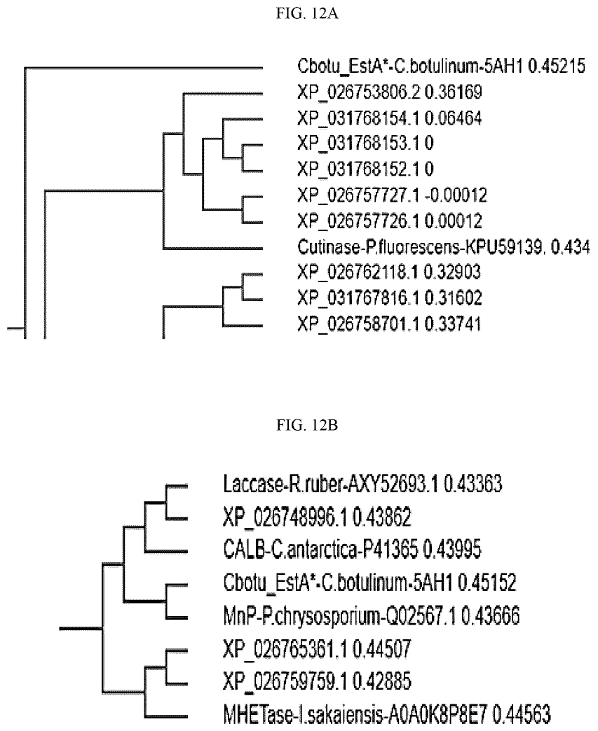

Due to the striking observation that our selected plastic degrading representative groups, and the full group of plastic degrading enzymes in Table 1 both showed phylogenetic similarities to candidates from a completely phylogenetically distant Wax moth, we opted to narrow the sample group even more down, to allow for a stricter representation of the function. We selected only 2-3 functionally characterized groups and we performed the same phylogenetic analysis with the full extent of both Wax moth families (Lipases 1,3) and Carboxylesterases, it confirmed all analyses done before and shed more light into the phylogenetic distance between some lipases/carboxylesterases and functional bacterial plastic degrading enzymes FIG. 12.

FIG. 12A shows candidate Lipases from G. mellonella phylogenetically close to functionally characterized PET degrading enzymes. *All enzymes starting with “X” are G. mellonella enzymes. The rest are functionally characterized.

FIG. 12B shows candidate Carboxylesterases from G. mellonella phylogenetically close to functionally characterized PET degrading enzymes. *All enzymes starting with “X” are G. mellonella enzymes. The rest are functionally characterized

Carboxylesterase family showed once more candidates than lipases with a very surprising phylogenetic clustering between Laccase from R. ruber and a potential candidate enzyme (FIG. 12. b), what is also notable is that when reviewing the study by (Cassone et al., 2020) it shows the abundance of bacterial communities related to PE diet in G. mellonella that can be correlated to enzymes above for instance the third highest phyla in G. mellonella fed with PE is Firmicutes to which the C. botulinum belongs as shown in FIG. 12, this also showed that plastic degradation may play a role in microbial evolution for such enzymes and in turn, these microbial communities might have inferred some of these genes through horizontal gene transfer (Cassone et al., 2020) & (Guevara et al., 2019).

Basic Local Alignment and Motif Analysis. BlastP was used for the selected candidates based on their phylogenetic distance and top 7 neighboring candidate wax moth enzymes to functionally characterized enzymes were subjected for further analysis, see Table 3. Candidate XP_026756911.1 (sequence incorporated by reference) although not part of the enzyme families that are under this study, was selected to proceed further, as it was very surprising the number of 4 motifs shared and the sequence coverage and identity when compared with a functionally characterized cutinase. Table 3 below shows levels of sequence similarity and Query coverage, it is worth mentioning that the sequence similarity is not the only determinant factor for this work which also considers structural similarity and functional motifs.

TABLE 3
BlastP values for Top 8 candidate enzymes of the greater
wax moth and functionally characterized enzymes

| | | Corresponding | | Seq | |
|---|---|---|---|---|---|
| | Functional | Enzyme in G. | Query % | Identity | |
| No | Enzyme | mellonella | Coverage | % | Conserved/Shared Motif |
| 1 | Cbotu_EstA | XP_026749408.1 | 8 | 28.6 | PF12697, Alpha/beta hydrolase |
| | 5AH1 | | | | family & PF00561, alpha/beta |
| | | | | | hydrolase fold |
| | | XP_026761831.1 | 2 | 58.3 | PF00561, alpha/beta hydrolase fold, |
| | | | | | PF12697, Alpha/beta hydrolase |
| | | | | | family, PF05057 & Putative serine |
| | | | | | esterase (DUF676) |
| | | XP_026749410.1 | 24 | 28.6 | PF12697, Alpha/beta hydrolase |
| | | | | | family & PF00561, alpha/beta |
| | | | | | hydrolase fold |
| 2 | CALBC | XP_026762526.1 | 40 * | 27.2 | PF07819, PGAP1-like protein |
| | P41365 | XP_026762525.1 | 40 * | 27.2 | |
| 3 | PETase | XP_026758376.1 | 14 | 30.2 | PF12695, Alpha/beta hydrolase |
| | GAP38373 | | | | family, , Serine aminopeptidase, S33 |
| | | | | | and PF00326, Prolyl oligopeptidase |
| | | | | | family. |
| | | XP_026764270.1 | 12 | 48.6 | PF12146, Serine aminopeptidase, |
| | | | | | S33, PF05448, Acetyl xylan esterase |
| | | | | | (AXE1 |
| 4 | Cutinase- | XP_026756911.1 | 85 * | 26.6 | PF00561, alpha/beta hydrolase fold, |
| | P. fluorescens- | | | | PF12697, Alpha/beta hydrolase |
| | KPU 59139.1 | | | | family, Serine aminopeptidase, S33 & |
| | | | | | PF01083 Cutinase. |

* High Query Coverage (Above 35%)

It came to our attention that from our investigation that motifs PF12697, Alpha/beta hydrolase family & PF00561, alpha/beta hydrolase fold played a crucial role in the ability of various plastic degrading enzymes to degrade plastic polymers efficiently. This is agreement with other studies that confirmed this notion (Kaushal et al., 2021), (Buchholz et al., 2022) & (Carr et al., 2020). It brings as well under the light the fact that it is a hallmark of cutinases and this as well strongly agrees with our phylogenetic analysis that was conducted (FIG. 7) and agreeing with the study by (Gambarini et al., 2022). More importantly, it also agrees with the fact that cutinases were environmentally evolved to break down cutin, another high molecular weight bio-polyester that is part of the natural habitat. Rendering the fact that, those cutinases have an advantage in their readiness to degrade other polymers that are synthetic and it might be the plausible cause TfCut 2 of T. fusca maintained its structure, while PETase of I. sakaiensis is plausibly a step forward in the evolution of such enzymes (Austin et al., 2018). Also, the fact that G. mellonella natural habitat is in bechives and agricultural fields, it does as well impose a plausible notion of horizontal gene transfer between cutinase rich environment and the Greater Wax moth, especially after noticing such surprising similarities in not only structure, but active motifs that otherwise would be difficult to explain their presence in the wax moth (Cassone et al., 2020) & (Guevara et al., 2019).

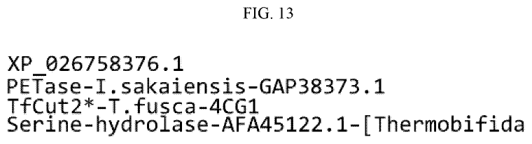

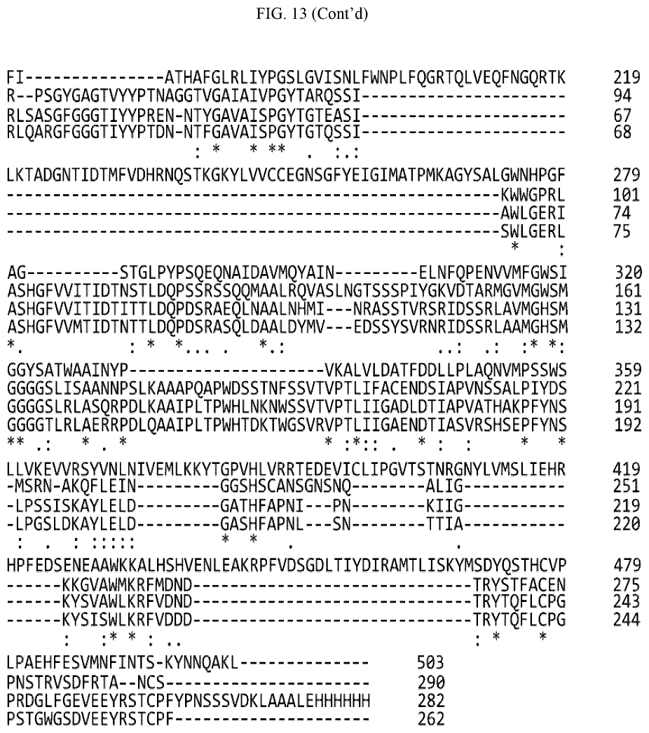

To build on motif analysis the inventors sought to perform multiple sequence alignment to investigate the presence of the catalytic triad of PETase (Ser160, His237, and Asp206) that is shared with many functional plastic degrading enzymes from a variety of organisms. The triad is usually studied for structural activity relationship and as the hallmark for plastic degradation nucleophilic attack and proceeding with hydrolysis of the synthetic polymers (Kitadokoro et al., 2019). The famous PETase enzyme (Accession No. GAP38373) was used, TfCut 2 (Accession No. 4CGI) and Serine Hydrolase (Accession No. AF45122) as distant yet plastic degrading enzymes that share the catalytic triad and also as an emphasis of the attributability of catalytic triad to plastic degradation even though from completely different organisms. The full alignments can be found in the Appendix below. Here we present the result for candidate: XP_026758376.1, it is the only candidate that showed full catalytic triad alignment with functional enzymes selected and on the same sequence distances. This is the first time in literature the catalytic triad of PETase (Ser160, His237, and Asp206) is reported in any species in the Lepidoptera order, in fact, this is the first report of PETase catalytic triad in any organism that does not belong to bacterial or fungi communities; see FIG. 13.

FIG. 13 provides a multiple sequence alignment of candidate enzymes from the greater wax moth and other functionally characterized enzymes for plastic degradation. The location of the catalytic triad of PETase and its relative conservation in the aligned sequences appear in the columns below S319, D344 and H84 (based on residues in SEQ ID NO: 1).

The rest of the candidate enzymes showed strong signs of conservation that varied in strength, however, at least one amino acid of the catalytic triad was always conserved as it is in all candidates Appendix which is incorporated by reference to the provisional priority application. Thus, five candidates were selected after these sequential filtrations to proceed with protein expression and characterization namely; XP_026749410.1 (SEQ ID NO: 5), XP_026762525.1, XP_026758376.1, XP_026764270.1, XP_026756911.1 (SEQ ID NO: 9), the sequences disclosed by each of the above accession numbers are incorporated by reference. In the sequence listing, XP_026762525.1, XP_026758376.1, and XP_026764270.1 were updated on Jun. 19, 2024 to XP 026762526.1 (SEQ ID NO: 6), XP_026758376.2 (SEQ ID NO: 7), and XP_026764270.2 (SEQ ID NO: 8).

### Example 2

### Incubation of Plastic Polymers with Candidate Enzymes

Rectangular coupons of size approximately ˜6×6 mm in diameter of 4 types of plastic polymer films namely; PET (Commercial Plastic Bottles stamped for confirmation from Nestle Waters Egypt), PLA (Packaging material of Amazon Egypt as stamped for identity), LDPE (Packing material from Greiner-Bio one and stamped for identity) and HDPE (Packing material from Serioplast Egypt, stamped for identity) were obtained from commercially available plastic to avoid the unrealistic behavior of high pure polymers and to mimic natural occurrence and the impact of degradation on realistic conditions. Coupons were weighed and then placed in a glass conical flask (50-mL) to avoid plasticware interfering with experimental results with the candidate enzymes. The digestion and incubation with crude enzymes sonicated for cell lysis was performed at 35° C.

Analysis of the films and supernatant was done after 1 week and second analysis after 2 weeks of digestion. Controls were also treated in the exact similar way, our +ve controls are PETase (PDB ID 6EQE) and MHETase (PDB ID: 6QGB). −ve controls were treated exactly the same manner+controls are treated with the exception that empty plasmids are used.

The reaction was terminated by removing the coupons from the culture and wiping them from residuals then washed with deionized water, ethanol was not used as it has shown to interfere with FTIR results, air dried for 14 hrs at room temperature and were sent for SEM and FTIR Characterization. (Austin et al., 2018).

During the work above, a pink coloration phenomenon of the induced controls and samples coming in contact with plastic polymers was noticed in the phase of protein pelleting and harvesting. A similar phenomena was reported by (Koconis, 2018) which suggested a proper system optimization.

### Example 3

### Scanning Electron Microscope Imaging of Plastic Surfaces Contacted with the Putative Enzymes Encoded by G. mellonella

SEM: Scanning Electron Microscopy. Scanning electron microscopy or SEM is a powerful imaging technique that provided high-resolution, three dimensional images of a plastic surface contacted with a protein encoded by G. mellonella. It used a focused beam of electrons to scan a plastic surface which produced signals that were resolved into images of the surface of the treated plastic polymers.

SEM imaging was performed using Leo Supra 55 Ultrahigh resolution SEM for the positive and negative controls and with JEOL JSM 6510 lv for the candidate enzymes, maintaining same parameters and magnification for the entire characterization, all samples were prepared by gold sputtering for 3 minutes prior to characterization, beam-accelerating voltage of 3-25 keV, to estimate surface topology change and structural integrity changes based on the contact duration with our enzymes of interest, samples were not completely cleaned from crude protein residues intentionally to be able to attribute enzyme damages and patterns of the topographical changes (Austin et al., 2018).

Surface Topography Study results using SEM. The incubation period was on two intervals starting with 1 week and ending at 2 weeks.

A positive control study utilizing the expressed PETase and MHETase as mentioned in the materials and methods and negative controls with empty plasmid bacterial cultures with the same treatment as the experiment design.

Successful positive controls and negative controls were assured by SEM topographical changes in plastic coupons under these conditions, all −ve controls showed no significant topography changes and all +ve controls showed severe topographical changes similar to those mentioned in literature (Atanasova et al., 2021).

FIGS. 14A-14D describe the effects of a negative control (first row), PETase (second row), MHETase (3^{rd} row), and both PETase+MHETase (4^{th} row) on selected plastic polymers after a two week exposure of the plastic to the enzymes. FIGS. 14A-14D respective refer to results on PET, PLA, LDPE and HDPE. PETase had the lowest surface topography change effect on PLA. While the latter is commercialized to be a biodegradable alternative to plastic, it is more resistant than previously thought and needs higher temperature than environmentally common (Mofokeng & Luyt, 2015). This was also the case here in the SEM study, although a much more evident degradation was seen when PETase when combined with MHETase. Overall the strongest levels of degradation were noted in both HDPE and PET. Highly crystalline PET was used.

HDPE subjected to PETase only has visual surface holes at 3500× magnification consistent throughout the sheet subjected to the enzyme with average diameter of topographical holes 10-12.7 micrometers.

MHETase had very low impact on topographical changes across all polymer types as its mechanism of action relies on degrading the intermediary product MHET rather than initial undegraded polymers, slits of MHETase impact were about 1.8 micrometer in longitudinal length, no holes were seen.

The impact of MHETase+PETase did not actually cause visual holes, but rather a complete degradation of the sheets in a way that the fabric of the plastic underlying layers could be seen in a much more consistent manner. All samples were taken via blind numbered imaging for more than 5 images per sample. For the most stringent case, the effects of PETase+MHETase exposure for two weeks were compared with the candidate enzymes from G. mellonella.

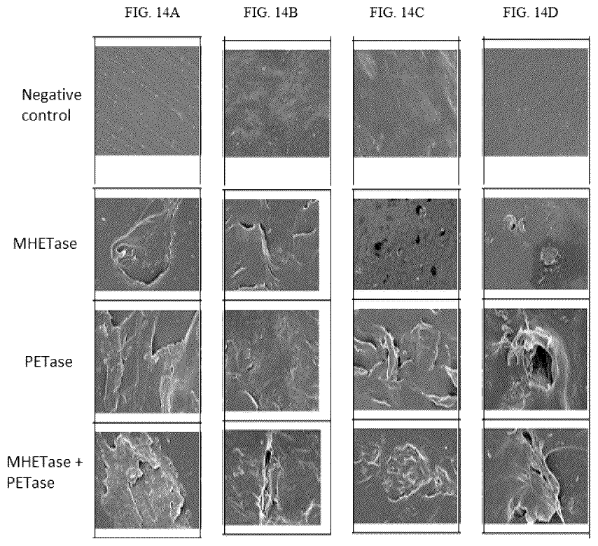

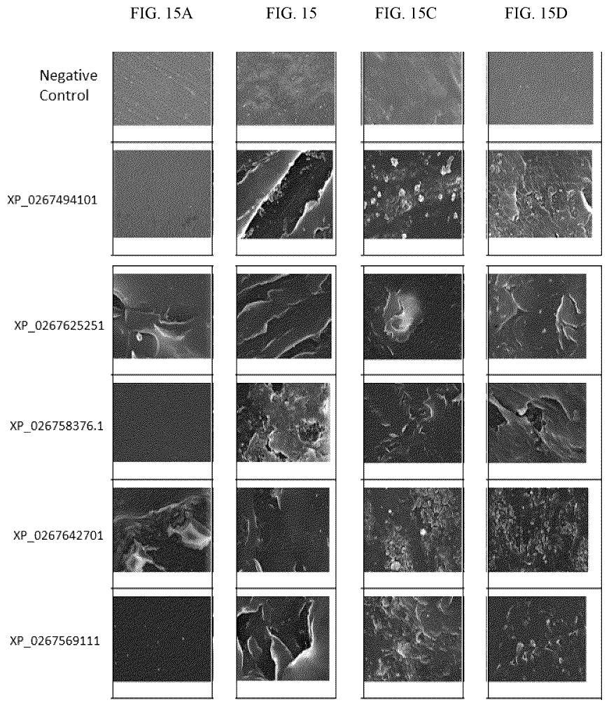

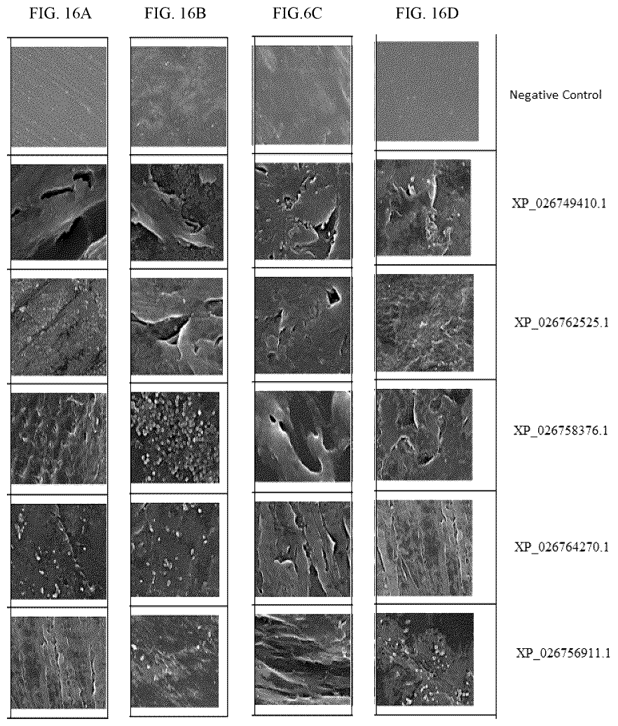

FIGS. 15 and 16. Five selected candidates were compared with negative controls at the two time intervals 1 week (FIG. 15) and 2 weeks (FIG. 16). FIG. 15 shows the effect of G. mellonella potential plastic degrading enzymes on selected plastic polymers after one week, FIGS. 15A-15D respectively describe effects on PET, PLA, LDPE, and HDPE.

It was surprising that various grades of surface topography were observed in almost all substrates that became more prominent in the second week.

It was found that at week 1 that only two candidates showed activity against the Crystalline Hard PET, namely; XP_0267625251 and XP_0267642701 (all sequences described by and incorporated by reference to their corresponding accession numbers). This was surprising especially because we can see no activity for candidate XP_026758376.1 that shared the complete catalytic triad of PETase and hinting at a potential needed studies for the impact of other motifs on the substrate binding and the availability of the catalytic triad.

All candidates showed topographically severe deformations when incubated with PLA, a fact that has not been reported before.

Both LDPE and HDPE showed similar patterns of topographical damages.

All topographical changes in week 1 were attributed to enzyme particles as we did not remove or completely wash the enzyme from the plastic coupons to be able to visualize the attributability of the enzymatic particles on the coupon surfaces.

It is very prominent that enzymatic particles had made grooves, holes and embedded themselves in the fabrics of the polymers as evident from FIGS. 15 and 16. All damages were assessed by measuring dimensions of the topographical mutilations and conclusions are made accordingly.

As shown by FIGS. 15A-15D, week 2 samples were prominently more damaged. Surprisingly, we could visualize PET polymer damage in all candidates, the delay in degradation might be attributed to crude protein concentrations or various other variables. Highest levels of PET topographical damages were visualized in candidates, XP_0267494101, XP_0267625251 and XP_026758376.1 respectively (each sequence described by and incorporated by reference to its corresponding accession number). FIGS. 16A-16D respectively describe the effect of G. mellonella potential plastic degrading enzymes on PET, PLA, LDPE, and HDPE plastic polymers after 2 weeks. The effect of candidate XP_026758376.1 was very prominent on PLA polymers. Holes made by enzyme particles and particles embedding themselves in the surface were clearly observed.

The SEM topography scans clearly indicate prominent damages are caused by all candidate enzymes by week two and potentially highlights the high plausibility of plastic polymers degradation. These candidate enzymes were never expressed in a bacterial system before to our knowledge and have never been characterized before.

### Example 4

### FTIR: Fourier Transform Infrared Analysis

Fourier Transform Infrared Spectroscopy or FTIR is a technique used to analyze the infrared absorbance or emission of a plastic sample. It measured the interaction between infrared light and the plastic sample, which provided information about the chemical bonds and functional groups present in the plastic exposed to proteins encoded by G. mellonella. It was used to identify and quantify organic and inorganic compounds present in the treated plastic, determine the molecular structure and analyze the chemical composition of the plastic sample contacted with a protein encoded by G. mellonella. In contrast to SEM which provided images the surface features of a treated plastic sample, FTIR provided a chemical analysis and identification of molecular components of the plastic sample.

Using the same drying method described in Example 1 above, coupons were wiped cleaned and left for air drying overnight. Untreated samples were used as control following same drying and washing protocol.

Samples were analyzed by Fourier Transform Infrared (FTIR) to characterize the results of breakdown using a Thermo Fisher Nicolet 380 Fourier Transform Infrared Spectrophotometer, (Thermo Fisher, USA).

The samples were placed facing in beam direction the Attenuated total reflectance (ATR) scanning were performed between 700 to 4000 cm⁻¹.

For every sample, background noise was corrected and four spectra were taken and average was recorded.

The spectra were assessed for breakdown intermediary or end product peaks for each and every substrate as for PET peaks for MHET, BHET are considered as intermediary products, and ethylene glycol as an end product of the degradation as highlighted by.

All controls +ve and −ve (positive and negative) were treated in the same manner.

FTIR Results. FTIR analysis was conducted to clearly identify whether surface topological damages to the plastic samples identified by the SEM results above were purely mechanical in nature or due to actual depolymerization and chemical structure breakdown of the plastic polymer samples. The FTIR analysis also served to determine whether there were structural spectral changes between different samples exposed to the different enzymes tested.

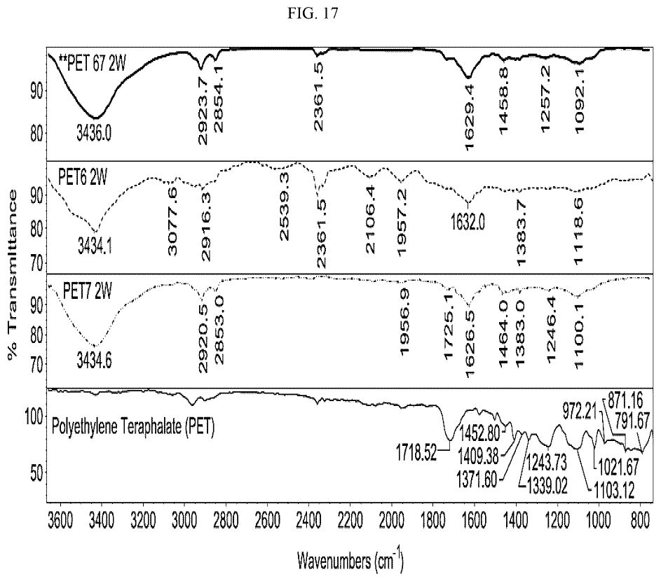

FIG. 17 shows the results of exposing the plastic polymers to different positive control enzymes. It shows that chemical breakdown was evident when different plastic polymers were subjected to incubation with the positive control enzymes that were previously and extensively studied for their plastic degradation abilities namely PETase and MHETase. These results show the impact of control enzymes vs. negative control on PET polymer FTIR spectrum. The red (bottom) line shows the negative control PET coupon without any changes in the molecular structure The orange (second line from bottom) line shows the impact of Control Functional Enzyme 7 (MHETase) after 2 weeks incubation. The green (third line from bottom) line shows the impact of Control Functional Enzyme 6 (PETase) after 2 weeks incubation. The blue (top) line shows the impact of Control Functional Enzyme 7 plus 6 in physical mixture in 1 to 1 ratio after 2 weeks incubation. The main purpose and judgment criteria of the FTIR study was to monitor the disappearance or appearance of new functional group peaks as indicated by the FTIR ATR spectrum or the changes denoted as reduction in polymeric peaks after being subjected to targeted enzymes; see Soni et al. 2009) and Sudhakara et al. 2008. To assure complete optimization and functionality of the experimental design, positive and negative controls were all subject to FTIR analysis.

FIG. 17 shows the results from the polymer PET control study. These showed 11 distinct peaks with 5 main peaks at 1718 (corresponding to C═O aliphatic ketone stretches), 1243 (corresponds to C—O stretches), 1103 (Secondary C—O stretches), 871 and 791 (bending ethyl C—H) respectively in cm⁻¹. Positive controls appear as in FIG. 17 after 2 weeks of incubation with PET Control 6 is the PETase enzyme, Control 7 is the MHETase enzyme. Control 67 is a 1 to 1 ratio mix of both enzymes. All positive controls showed clear peaks around 3400 cm⁻¹ corresponding to O—H stretches in alcohols a clear indicative feature of chemical breakdown of the polymeric structure into the end product of ethylene glycol; see Bombelli et al., 2017. Peak reductions were noticed in various grades across the rest of the main 5 peaks indicating a clear depolarization action and proper expression and degradation caused by the functionally characterized controls. LDPE and HDPE showed similar patterns, however intramolecular alcoholic bands could not be clearly visualized as expected from the washes done to plastic coupons and the high solubility of EG and the structural differences between the polymers. However, strong peak reductions were noticed in line with expected results.

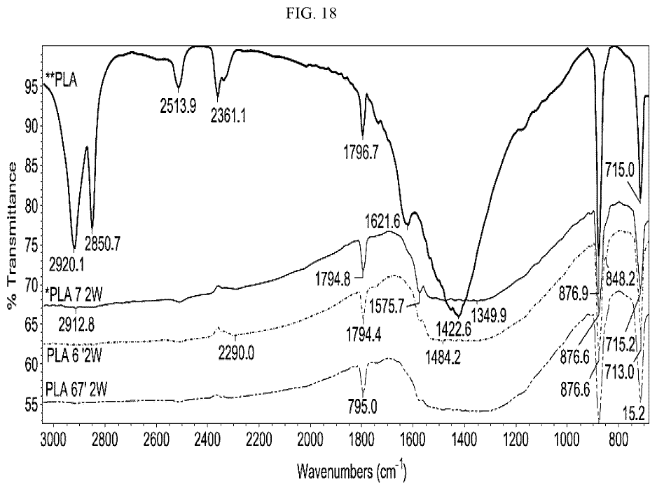

FIG. 18 describes a FTIR Overlaid Spectrum for PLA Polymer subjected to control enzymes 6,7 and 67. Common scale FTIR spectrum for PLA polymer.

The blue (top) line indicates the negative control polymer, red (third from bottom) line below shows control enzyme 7 impact on PLA spectrum, the pink (second from bottom) line indicates the impact of control enzyme 6 and dark blue (bottom) line indicates the impact of control enzyme 67 a mix of 6 and 7 in 1 to 1 ratio.

FIG. 18 shows the effect of positive control enzymes on PLA. It was interesting to study the effect of functionally characterized enzymes on PLA polymer, a polymer that is commercialized as biodegradable, however in environmental conditions it is not really the case, as in most cases it requires industrial compost conditions and temperatures up to 200 degree Celsius.

Disappearance or severe reduction of peaks at 2920 and 2850 cm⁻¹ was observed in FIG. 18 indicating a depolymerization action to the C—H stretches of the polymer.

The highest effect was seen in control 67 the physical mixture between controls 6 and 7.

Also, reduction of C—O binding at 1796 and complete flattening of C—H bending peak at 1422 and C—O stretches. This indicated a chemical breakdown of the polymer at relative environmental temperatures and higher than the rates reported by (Andreia Araújo et al., 2013) through photooxidation. The observation that PETase and MHETase had an effect on PLA is promising for use of these enzymes to degrade plastic.

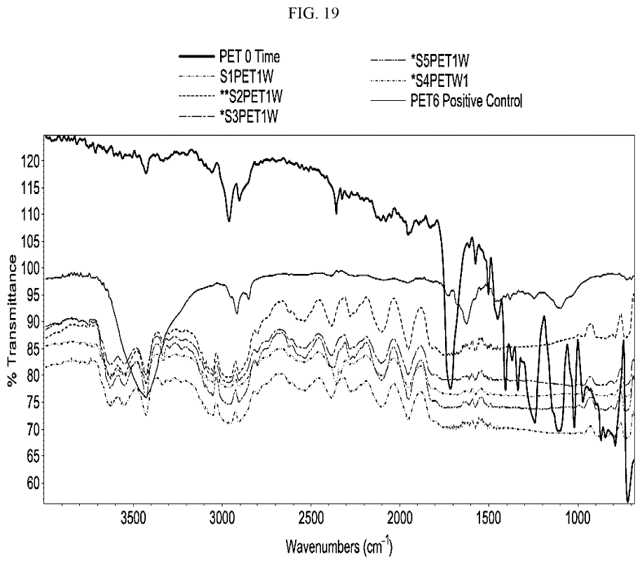

FIG. 19 describes the effects of various Candidate enzymes on PET polymer for an incubation duration of 1 week compared against control study. The FTIR of the candidate enzymes' effects on different polymers can be seen in FIGS. 19 to 26 below.

Similar patterns of peak reduction and transmittance reduction were noticed across all candidate enzymes, with a different pattern noticed in control enzyme 6 (PETase).

All candidate enzymes showed clear and sharp peaks around 3400 cm⁻¹ corresponding to alcoholic O—H a wider band was seen in control 6.

Aliphatic ketone stretches around 1700 cm⁻¹ almost disappeared completely from all candidate enzymes, while shifted in the control no. 6 proposing a potential complete degradation mode rather than a 2 step process in controls 6 and 7.

The same goes for 1200 and 1100 cm⁻¹ C—O stretches complete flattening or absence of the peaks compared to reduction only in control 6.

All in all an overall decrease in transmission sheds light as well into more degradation compounds compared to those in other spectra, with the highest peak reduction effects seen in enzyme candidate 4 (Table. 2).

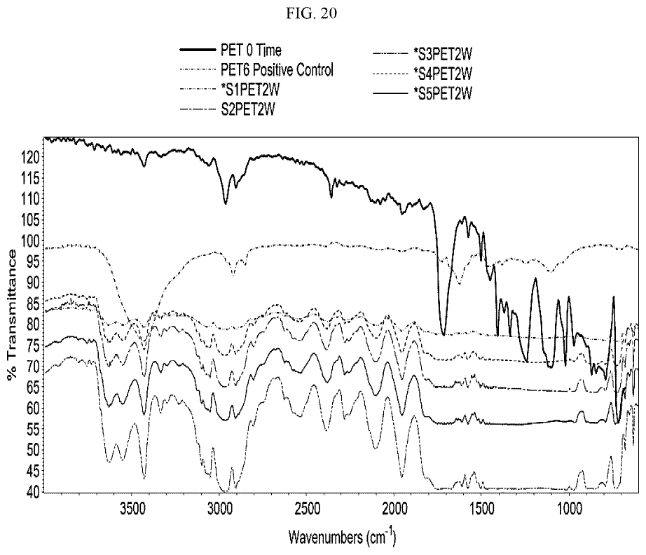

FIG. 20 describes the effects of various Candidate enzymes on PET polymer for an incubation duration of 2 weeks compared against control study. The two weeks study of PET polymer showed more intensified decreases in transmittance patterns and variances in peak intensity as shown by FIG. 20. Similar patterns can be observed with the 1 week study. Candidate 3, followed by sample 5, appears to be responsible for the highest reduction in transmittance.

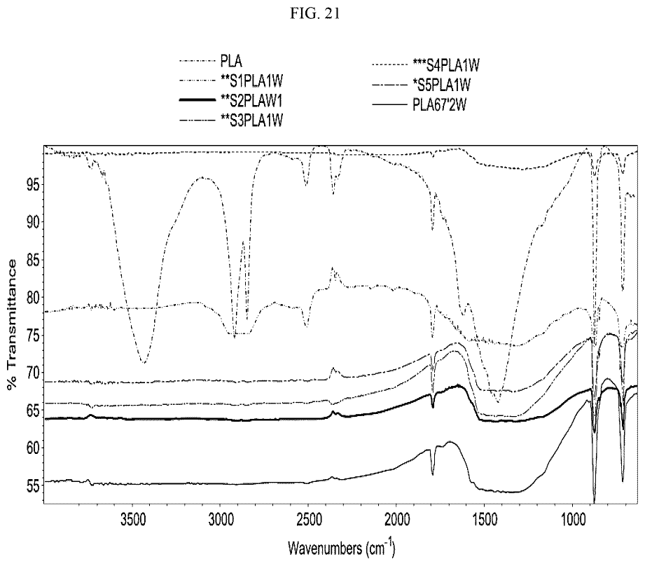

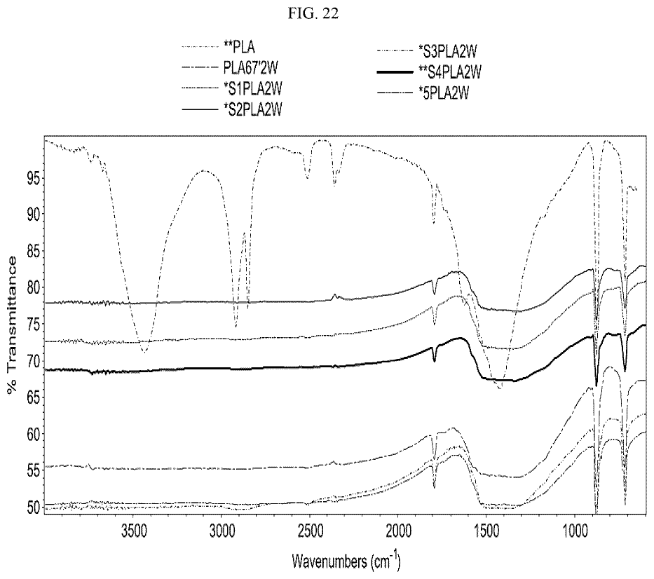

FIGS. 21 and. 22 show the impact of the candidate enzymes on PLA polymer after incubation for 1 and 2 weeks respectively. It was evident that peaks associated with C—H stretches from all candidates in both studies, located between 2800-3000 cm⁻¹ in the original polymer, have completely disappeared/flattened, except for candidate 1, week 1 shown in orange in FIG. 22. That candidate exhibited peaks that were less impacted than others indicating a lower activity compared to the rest of candidates. Peaks related to ester C—O and located around 1700 cm⁻¹ decreased in intensity significantly. The highest peak reduction was observed in candidate 2 in both studies. The well-defined peak in the original polymer located at 1300-1500 cm⁻¹, corresponding to vibration of C—H groups in CH₃, was clearly decreased in intensity. This is clearly indicative of biodegradation action. The highest reduction effects were seen in candidate 1, 2. Peaks at 900-1000 cm⁻¹ corresponding to C—O stretching vibration were also observed to be decreased with the highest reduction seen in candidate 1, 2. These results suggest that these enzymes might have different affinities towards different functional groups and with overall highest activity seen in candidate 1,2 that is higher than the most stringent control no. 67. Also, overall reduction in transmittance % could be seen across all candidates.

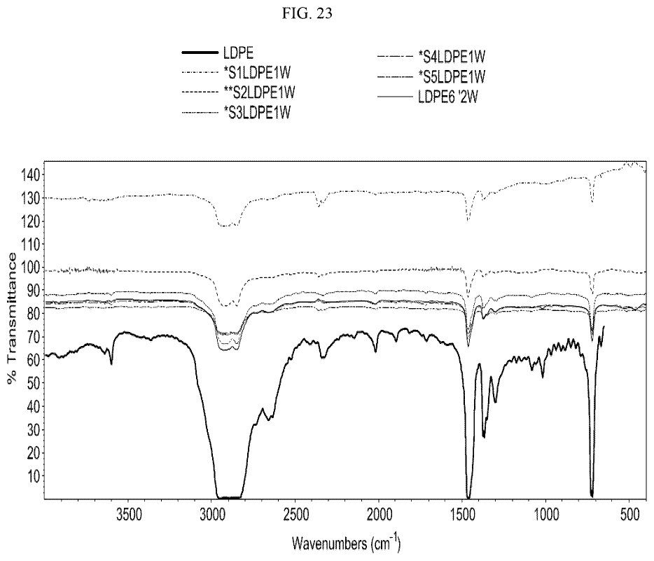

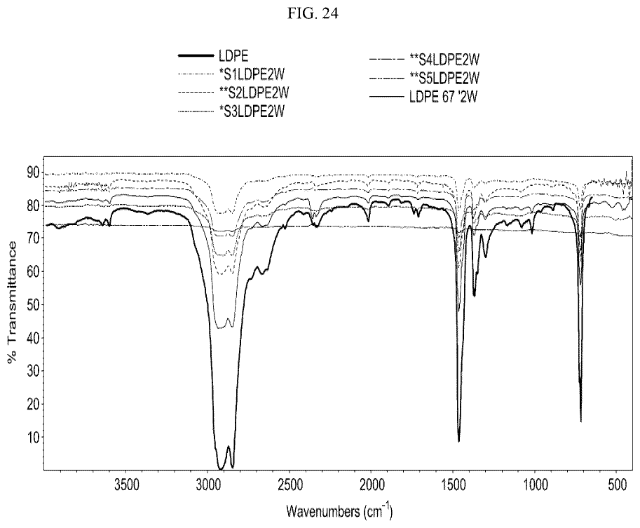

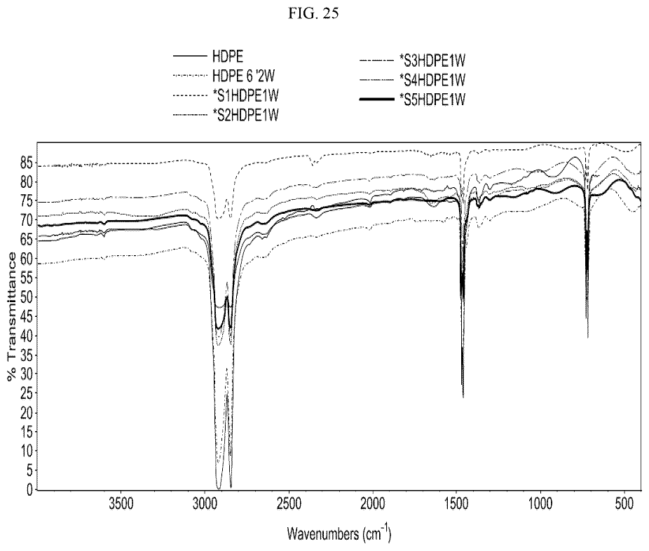

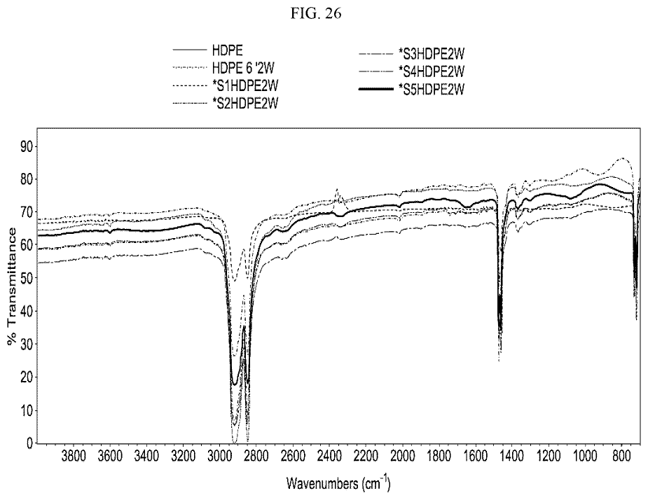

FIGS. 23-26 show the impact of candidate enzymes and control enzymes against LDPE and HDPE on 1 week and 2 weeks intervals respectively. Specifically, FIG. 23 shows the effect of various Candidate enzymes on LDPE polymer for an incubation duration of 1 week compared against control study. FIG. 24 shows the effect of various Candidate enzymes on LDPE polymer for an incubation duration of 2 weeks compared against control study. FIG. 25 shows the effect of various Candidate enzymes on HDPE polymer for an incubation duration of 1 week compared against control study. FIG. 26 shows the effect of various Candidate enzymes on HDPE polymer for an incubation duration of 2 weeks compared against control study.

All spectra were subjected to common scale again for better judgment of the graphs.

The main characteristic peak at 2700-3000 cm⁻¹ corresponding to the C—H stretching was significantly impacted by different candidates in both HDPE and LDPE groups.

The impacts across all Figures were similarly related to this functional group and highest reduction impact can be seen by candidate 1,2.

Interestingly, there were more prominent changes compared to positive controls in all studies, including the most stringent control 67.

Next major peak at 1400-1500 cm⁻¹ resembling the vibrating overlapping peaks for C—H groups was clearly reduced by all candidates and the control enzymes, however the impact of controls is much more prominent than the controls including the stringent control no. 67.

Out of all candidates, candidate 1 and 2 again showed the greatest peak reduction. Methylene group rocking vibration peaks around 700-750 cm⁻¹ as the last major peak can be seen reduced in all candidates.

Interestingly, the largest reduction could be seen in candidates 4 and 5 highlighting again the different affinities of different enzymes towards different functional groups.

All in all, the greatest reduction and transmission shifts could be attributed to candidates 1 and 2 for LDPE and HDPE polymers.

As shown, herein, based on a comparative bioinformatic analysis of putative plastic degrading enzymes encoded by genes in the G. mellonella genome with enzymes encoded by other organisms including bacterial and fungal enzymes, the inventors identified a set of candidate enzymes from G. mellonella. These candidate enzymes were recombinantly expressed, contacted with plastic polymers, and demonstrated to degrade plastic polymers by both SEM and FTIR to degrade a variety of different plastic polymers.

This work provides phylogenetic evidence of evolutionary neighboring candidates in the genome of G. mellonella to functionally characterized plastic degrading enzymes with clear separation and clustering of some candidates with functionally characterized microbial or fungal enzymes, the fact that a G. mellonella's proteins are found to be more phylogenetically close to bacterial or fungal proteins than they are to their own family of enzymes either carboxylesterase or lipase is a very interesting and novel notion that sheds more light into the ability of the greater wax moth to digest and utilize plastic polymers as carbon source and how it evolved this ability.

The inventors also identified shared functional motifs that are common in plastic degrading enzymes. These motifs were shown to be conserved in their phylogenetic neighboring enzymes from G. mellonella. The most common shared motif was PF12697 in the alpha/beta hydrolase family.

The inventors' observation of identical shared catalytic triad amino acid sequences on the same distances as that in PETase enzyme in the pool of candidate enzymes from the greater wax moth, suggested the possibility of horizontal gene transfer between microbial communities and the greater wax moth in the development of the ability or to degrade plastic.

Both chemical and physical evidence showed that the surface topography and chemical structure of various plastic polymers was altered when contacted with the candidate enzymes identified from the greater wax moth. This included the effects of PETase, MHETase on PLA polymer. These changes are relatable to biodegradation of the plastic polymers and could be seen to be even more significant than those inferred by positive control enzymes from Ideonella sakaiensis. The candidate enzymes from G. mellonella are the first carboxylesterase and lipase enzymes expressed in a bacterial system and characterized for plastic degradation abilities in the whole Lepidoptera order

### Example 5

### 3D Modeling and Structural Analysis of Candidate Enzymes

### Supporting Results for the Plastic Degrading Enzymes

Structure analysis. Three-dimensional structure models of the candidate enzymes from Galleria mellonella were generated using AlphaFold2 server (Jumpe et al., 2021). PyMOL (DeLano Scientific LLC, San Carlos, CA, USA) (DeLano et al., 2002) and UCSF ChimeraX (Pettersen et al., 2021) molecular visualization systems were utilized for structural superposition and visualization.

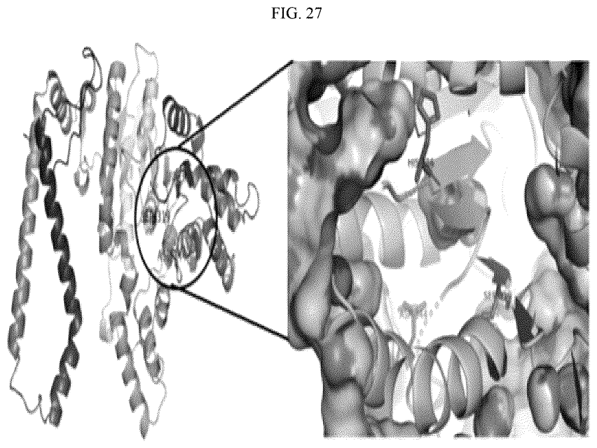

FIG. 27 shows the 3D model of XP_026758376.1 enzyme resolved by alphaFold2 with the full catalytic triad illustrated at S319, D344 and H386.

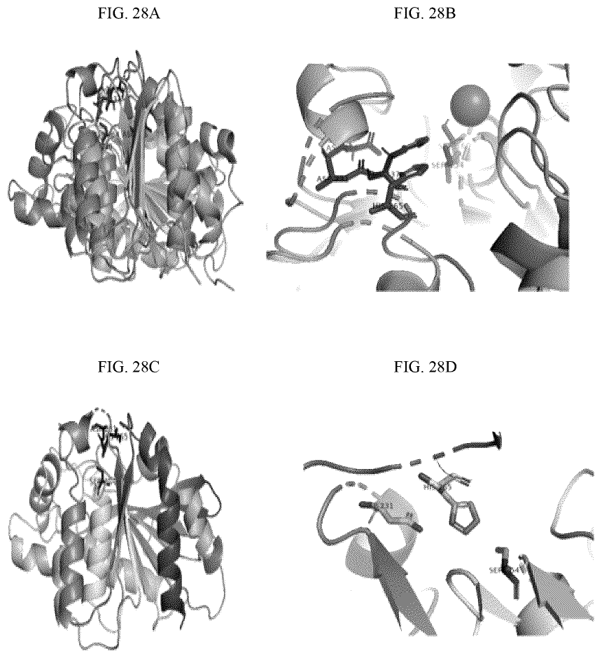

FIG. 28 shows the results of structure analysis of G. mellonella enzyme XP-026764270.1 compared to Ideonella akinesis PETase (IsPETase). Structural analysis and superposition of G. mellonella enzyme candidate enzymes with benchmark Ideonella sakaiensis PETase (IsPETase) was done to investigate the potential catalytic triad for such enzymes. Superposition of G. mellonella enzyme XP-026764270.1 to IsPETase showed that it might have a full catalytic triad at positions S154, D231, H265.

FIG. 28A: Structure superimposition of IsPETase (Magenta) with candidate enzyme XP-026764270.1 (Green) with executive 1093 atoms aligned with RMSD calculated at 3.52 A and MatchAlign score 292.754. FIG. 28B: Predicted catalytic triad of candidate enzyme XP-026764270.1 (Red) compared to IsPETase catalytic triad (Blue). FIG. 28C: Three-dimensional structure model of Galleria mellonella enzyme XP-026764270.1 predicted by AlphaFold2. FIG. 28D: Predicted Catalytic triad of XP-026764270.1 enzyme showed at S154, D231, H265.

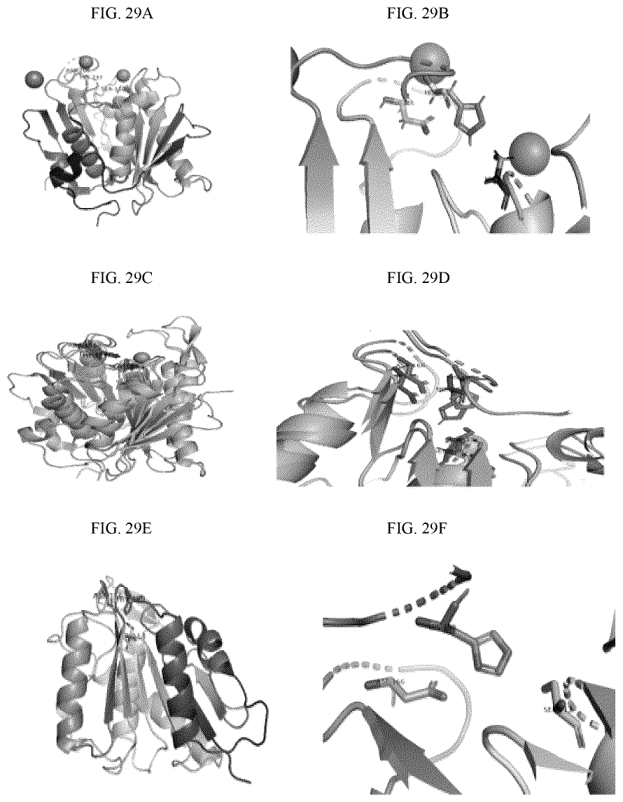

FIG. 29 shows the results of structure analysis of G. mellonella enzyme XP-026762525.1 compared to Ideonella sakaiensis PETase (IsPETase). G. mellonella enzyme XP-026762525.1 showed a catalytic triad predicted at S113, D166, H198 upon structural superposition to IsPETase. FIG. 29A: 3D model of IsPETase (PDB ID 6EQE). FIG. 29B: Schematic representation of IsPETase catalytic triad (S160, D206, H237). FIG. 29C: FIG. 29C: Structure superimposition of IsPETase (Green) with candidate enzyme XP-026762525.1 (cyan) with RMSD calculated at 2.99 A. FIG. 29D: Catalytic triad of candidate enzyme XP-026762525.1 (Magenta) compared to IsPETase catalytic triad (Red). FIG. 29E: Three-dimensional structure model of G. mellonella candidate enzyme XP-026762525.1. F) Predicted catalytic triad of XP-026762525.1 enzyme showed at S113, D166, H198.

### Example 6

### Gas Chromatography-Mass Spectrometry (GC MS) Analysis

The efficiency of plastic biodegradation of wax moth enzymes was further investigated using GC-MS analysis. Specifically, the wax moth enzyme lipase (XP_026758376.1) and the positive control enzyme PETase were employed in this study. The degradation products/intermediates released into the media after treatment with LDPE powder were identified and analyzed by GC-MS.

PE powder preparation: LDPE powder with a particle size of 300 μm was purchased from ChemicalStore.com and used in this study. The PE powder was prepared according to Zhang et al. (2022) J Hazard Mater. 2022 Oct. 5; 439:129656. doi: 10.1016/j.jhazmat.2022.129656. Epub 2022 Jul. 21. PMID: 36104922. Briefly, the particles were first soaked in 90% ethanol for 1 h followed by washing with 70% ethanol for an additional 1 h, then dried at 40° C. prior to use.

Protein expression and extraction. Single colonies from fresh plate of each transformed cells, wax moth lipase enzyme (XP_026758376.1) and PETase positive control, was inoculated into LB media containing 50 μg/ml Kanamycin, cultures were allowed to grow overnight at 37° C., then 100-fold dilution of starter culture were inoculated into LB medium containing 50 μg/ml Kanamycin. The culture was kept at 37° C. until the OD reached 0.8 at 600 nM. Protein expression was then induced by adding IPTG at a final concentration of 0.25 mM at 150 rpm and 25° C. overnight (16 h). The cell pellets were then harvested by centrifugation (1500×g for 20 min) and stored at −80° C. until protein extraction. Enzyme extraction from induced bacterial pellets was initiated by exposing the pellets to multiple cycles of freezing and thawing, and then re-suspended at 4 ml/g cells in lysis buffer (20 mM sodium phosphate, 0.5 M NaCl, 20 mM imidazole, pH 7.4). The cell suspension was sonicated on ice for three 30-second bursts with 30-second intervals on ice using a Soniprep 150 Plus instrument (MSE, London, UK). The cell lysate was collected after centrifugation at 15000×g for 20 min at 4° C. The supernatant containing induced protein was collected and the cell debris were collected and re-suspended in lysis buffer and subjected to another cycle of extraction as mentioned before to ensure full extraction of all the induced protein. The protein concentration for the extract was determined using the Bicinchoninic acid (BCA) assay kit (Thermo Scientific, USA), from the standard curve using bovine serum albumin as standard. The accuracy of the BCA assay was calculated from the standard curve and found to be 99.44% (R² 0.991). After the protein extraction from bacterial pellets, the protein extract for each enzyme was equally divided into two vials. One vial served as a control sample without treatment with LDPE powder, while the other was incubated with LDPE powder and served as the treated sample.

Treatment with LDPE powder. 100 mg of dried LDPE powder was incubated with 10 ml of crude protein extract (4.5±0.2 mg/ml) of wax moth lipase enzyme as well as PETase enzyme for 72 h at 30° C. After incubation period, the reaction mixture was centrifuged, and supernatant was filtered through 0.22 um membrane filter to remove any remaining LDPE powder. The filtrate was then mixed with equal volume of ethyl acetate and injected into GC-MS for identification of LDPE degradation product. Control samples containing the protein extract before treatment with LDPE were also mixed with equal volume of ethyl acetate and analyzed by GC-MS.

### Results

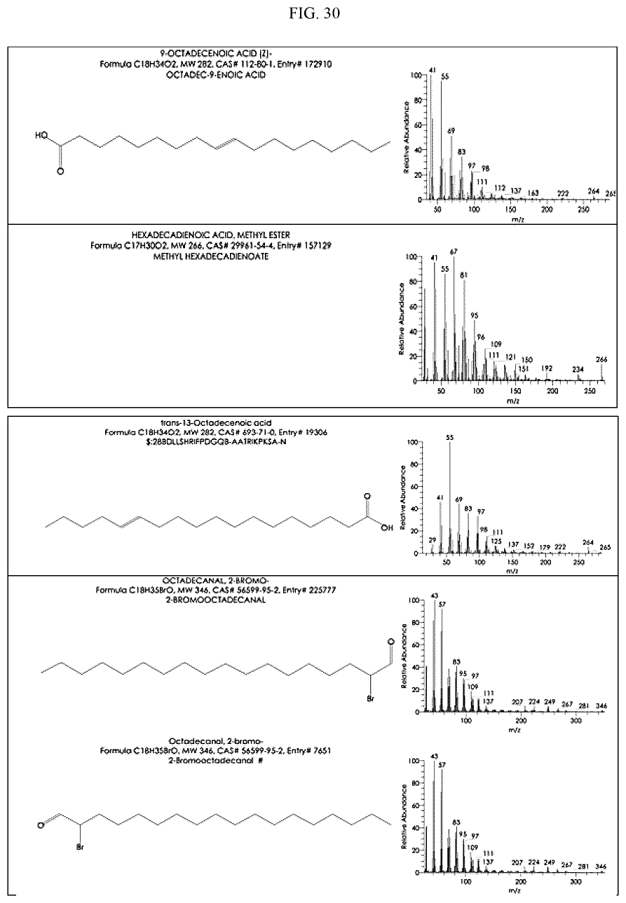

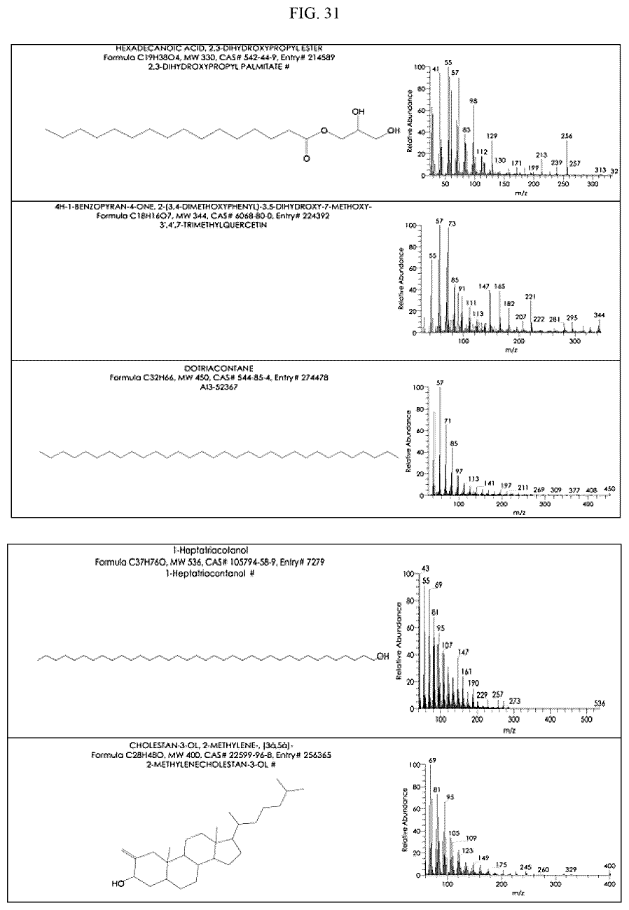

Degradation products of LDPE powder after incubation with wax moth lipase enzyme. Based on the GC-MS analysis of the bacterial protein extract containing wax moth lipase enzyme after incubation with LDPE at 30° C. for 72 hours, several observations can be made regarding the degradation products formed. Table 1 represents list of compounds identified only in the treated samples compared with control. These compounds include long chain hydrocarbon like 9-octadecenoic acid (Z), ester of fatty acid such as Hexadecadienoic acid methyl ester and aldehyde like Octadecanal. Shilpa et al. (2023) Biodegradation. doi: 10.1007/s10532-023-10061-2 have reported detection of intermediate products from GC-MS analysis of the crude extract of Pseudomonas aeruginosa WD4 after treatment with LDPE such as long chain fatty acid (octadecanoic, hexadecanoic acid), aldehyde and hydrocarbons. Kyaw et al. (2012) Indian J Microbiol 52:411-419. doi.org/10.1007/s12088-012-0250-6 have reported similar intermediate products including fatty acids (such as Hexadecanoic acid and Octanoic acid), hydrocarbon alkanes and ester group of alcohols, after GC-MS analysis of LDPE degradation by Pseudomonas species. The chemical structure and the corresponding peaks for the identified compounds are shown in FIG. 30.

TABLE 1
A list of compounds exclusively detected in the reaction
mixture of LDPE treated with wax moth lipase for 72 h.

| | Putative | Chemical | M/Z | Compound |
|---|---|---|---|---|
| Enzyme | identification | formula | value | classification |
| wax moth | 9-octadecenoic | C₁₈H₃₄O₂ | 282 | Unsaturated |
| lipase enzyme | acid (Z) | | | fatty acid |
| (XP_{—} | Hexadecadienoic | C₁₇H₃₀O₂ | 266 | Fatty acid |
| 026758376.1) | acid, methyl ester | | | ester |
| | trans-13- | C₁₈H₃₄O₂ | 282 | Unsaturated |
| | Octadecenoic acid | | | fatty acid |
| | Octadecanal, 2- | C₁₈H₃₅BrO | 346 | Aldehyde |
| | bromo- | | | |

FIG. 30 shows the chemical structure and the corresponding peaks for the LDPE degradation products exclusively identified by GC-MS in samples treated with wax moth lipase for 72 h compared to control. Additionally, several compounds were also detected in treated samples in high intensity compared to the control sample (Table 2). These compounds include long-chain alcohols (1-Heptatriacotanol), long-chain alkanes (Dotriacontane), glycerol esters (Hexadecanoic Acid, 2,3-Dihydroxypropyl Ester), complex aromatic compounds (4H-1-Benzopyran-4-one, 2-(3,4-dimethoxyphenyl)-3,5-dihydroxy-7-methoxy) and sterol derivative (Cholestan-3-ol, 2-methylene). The chemical structure for the detected compounds with their corresponding type are illustrated in FIG. 31.

TABLE 2
GC-MS degradation products identified in high intensity in LDPE
sample treated with wax moth lipase for 72 h compared to control.

| | | Chemical | M/Z | Compound |
|---|---|---|---|---|
| Enzyme | Putative identification | formula | value | classification |
| wax moth | Hexadecanoic Acid, 2,3- | C₁₉H₃₈O₄ | 330 | glycerol esters |
| lipase enzyme | Dihydroxypropyl Ester | | | |
| (XP_026758376.1) | 4H-1-Benzopyran-4-one, 2-(3,4- | C₁₈H₁₆O₇ | 344 | complex aromatic |
| | Dimethoxyphenyl)-3,5-Dihydroxy- | | | compounds |
| | 7-Methoxy- | | | |
| | Dotriacontane | C₃₂H₆₆ | 450 | long-chain alkanes |
| | 1-Heptatriacotanol | C₃₇H₇₆O | 536 | Fatty alcohols |
| | Cholestan-3-ol, 2-methylene-, (3á,5à)- | C₂₈H₄₈O | 400 | sterol derivatives |

FIG. 31 shows the chemical structure and the respective peaks for the degradation products identified in high peak areas in LDPE sample treated with wax moth lipase for 72 h compared to control.

GC-MS analysis of Degradation products of LDPE powder by PETase enzyme. A wide range of hydrocarbon compounds were identified by GC-MS for samples treated with PETase enzyme after incubation with LDPE powder for 72 h at 30° C. PETase enzyme produced large number of compounds ranged from C6 to C32 carbon compounds (Table 3). Notably, short chain alkane (Hexane) and alkene (Hexene) as well as long chain hydrocarbon were detected in high intensity in treated sample compared with control, suggesting release of plastic byproduct into the control sample media during induction and extraction process as a result of enzyme degradation to plastic falcons and/or containers.

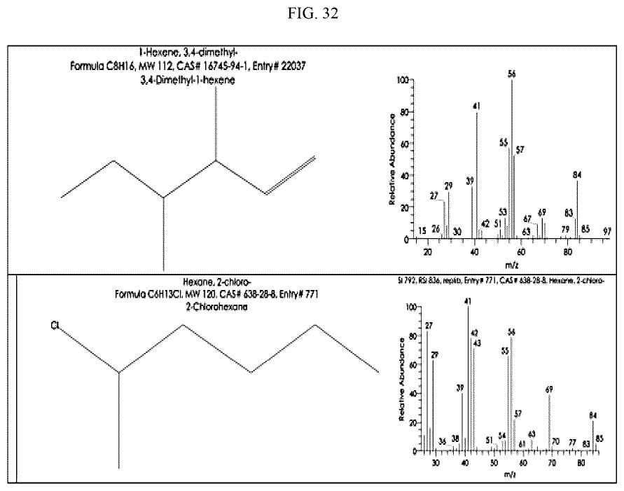

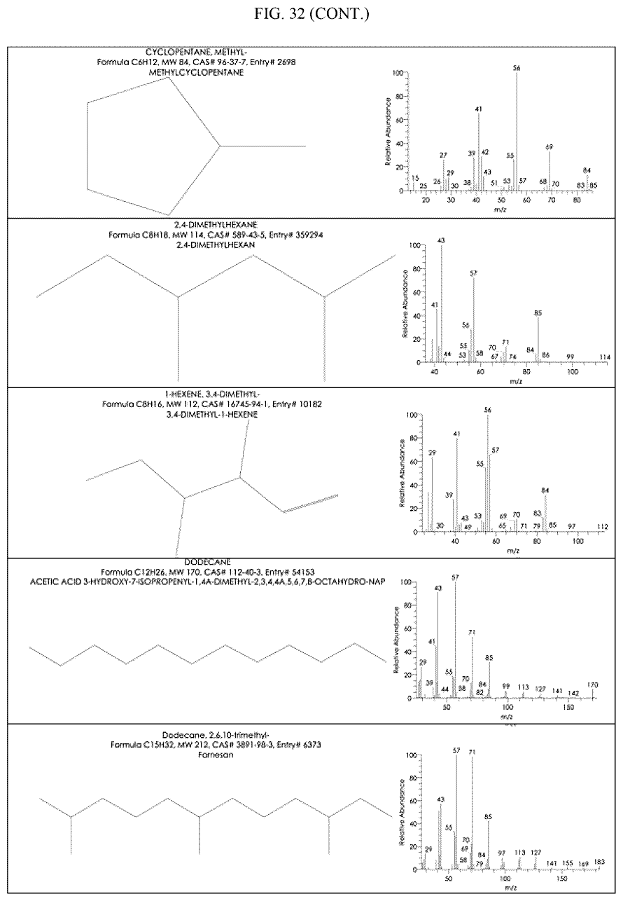

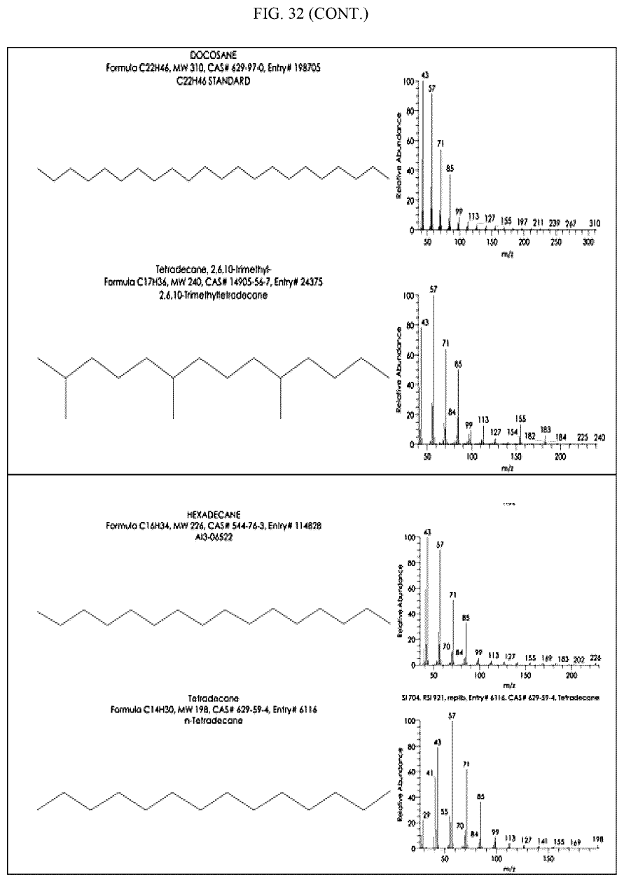

Unlike wax moth lipase enzyme, PETase enzyme produced short chain alkane (Hexane, 2-chloro, Hexane, 2,4-dimethyl, and cyclopentane, methyl) and alkene (1-Hexene, 3,4-dimethyl). These compounds are also detected in control sample, suggesting release of these compounds due to the degradation of the plastic material used during the extraction process. The different peak intensity of same retention time in the treated sample and the control is considered as potential degradation product for mass spectrum analysis, FIG. 32. Long chain alkanes such as Dodecane, Tetradecane, Pentadecane, Hexadecane, Heptadecane, Docosane, Eicosane, Heptacosane, Dotriacontane are also detected suggesting the degradation of polymer chains into smaller hydrocarbon units. Similarly, Rong et al. (2024) Sci Total Environ. 2024 Jan. 10; 907:167993. doi: 10.1016/j.scitotenv.2023.167993 reported the release of potentially degrading product such as short and long chain alkanes and alkene, carboxylic acid and alkanol products after treatment of LDPE with Rhodococcus sp. C-2 strain confirming the depolymerization of LDPE by Rhodococcus sp. through cleaving long carbon chains via multi-step reactions such as hydroxylation and oxidation, generating hydrophilic groups as well as releasing short-chain products.

TABLE 3
GC-MS degradation products identified in high intensity in LDPE
sample treated with PETase for 72 h compared to control.

| | | Chemical | | |
|---|---|---|---|---|
| Treatment | Compounds | formula | M/Z value | Classification |
| PETase | 1-Hexene, 3,4-dimethyl- | C₈H₁₆ | 112 | Short chain Alkene |
| enzyme | Hexane, 2-chloro- | C₆H₁₃Cl | 120 | Short chain Alkane |
| (positive | Cyclopentane, methyl- | C₆H₁₂ | 84 | Short chain Cycloalkane |
| control) | Hexane, 2,4-dimethyl- | C₈H₁₈ | 114 | Short chain Branched Alkane |
| | Dodecane | C₁₂H₂₆ | 170 | Long chain Alkane |
| | Dodecane, 2,6,10-trimethyl- | C₁₅H₃₂ | 212 | Long chain Branched Alkane |
| | Tetradecane | C₁₄H₃₀ | 198 | Long chain Alkane |
| | Tetradecane, 2,6,10-trimethyl- | C₁₇H₃₆ | 240 | Long chain Branched Alkane |
| | Pentadecane | C₁₅H₃₂ | 212 | Long chain Alkane |
| | Hexadecane | C₁₆H₃₄ | 226 | Long chain Alkane |
| | Docosane | C₂₂H₄₆ | 310 | Long chain Alkane |
| | Eicosane | C₂₀H₄₂ | 282 | Long chain Alkane |
| | Heptacosane | C₂₇H₅₆ | 380 | Long chain Alkane |
| | Heptadecane | C₁₇H₃₆ | 240 | Long chain Alkane |
| | Dotriacontane | C₃₂H₆₆ | 450 | Long chain Alkane |

FIG. 32 shows the chemical structure and the respective peaks for the degradation products identified in high peak areas in LDPE sample treated with PETase for 72 h compared to control.

Description of other enzymatically active sequences which may be used in conjunction with the products and methods disclosed herein.

### Lipases & Hydrolase Enzymes

XP_026756911.1 abhydrolase domain-containing protein 2 [Galleria mellonella]
XP_026764270.1 S-formylglutathione hydrolase isoform X2 [Galleria mellonella]
XP_026757727.1sn1-specificdiacylglycerollipasebeta-likeisoformX4[Galleriamellonella]
XP_026757726.1sn1-specificdiacylglycerollipasebeta-likeisoformX3[Galleriamellonella]
XP_026752828.1lipase1-like[Galleriamellonella]
XP_026752707.1lipase1-like[Galleriamellonella]
XP_026752593.1lipase1-like[Galleriamellonella]
XP_026752173.1lipase3-like[Galleriamellonella]
XP_026752077.1lipasememberI-like[Galleriamellonella]
XP_026751685.1lipase3-like[Galleriamellonella]
XP_026750724.1lipase3-like[Galleriamellonella]
XP_026750350.1lipase3-like[Galleriamellonella]
XP_026749708.1lipase3-like[Galleriamellonella]
XP_026749692.1lipasememberI-like,partial[Galleriamellonella]
XP_026748699.1lipase 1-likeisoformX1[Galleriamellonella]
XP_026764551.1lipase3-like[Galleriamellonella]
XP_026763238.1lipase3[Galleriamellonella]
XP_026763237.1lipase3-like[Galleriamellonella]
XP_026762703.1lipase1-like[Galleriamellonella]
XP_026762162.1lipase1-like[Galleriamellonella]
XP_026762118.1lipasememberI-like[Galleriamellonella]
XP_026761137.1lipasememberH-B-like[Galleriamellonella]
XP_026759411.1lipasememberH-A-like,partial [Galleriamellonella]
XP_026759065.1lipase3-likeisoformX2[Galleriamellonella]
XP_026759064.1lipase3-likeisoformX1[Galleriamellonella]
XP_026759062.1lipase3-like[Galleriamellonella]
XP_026756354.1endotheliallipase [Galleriamellonella]
XP_026754692.1lipase3-like[Galleriamellonella]
XP_026754669.1lipase 1-like[Galleriamellonella]
XP_026753522.1lipase 1-like[Galleriamellonella]
XP_026753514.1lipase3-like[Galleriamellonella]
XP_031769054.1lipasememberH-likeisoformX3[Galleriamellonella]
XP_031768708.1lipasememberH-A-like[Galleriamellonella]
XP_026762736.2lipasememberH-A-like[Galleriamellonella]M>
XP_031768633.1lipase3-like[Galleriamellonella]
XP_031768220.1sn1-specificdiacylglycerollipasebeta-like[Galleriamellonella]
XP_031768154.1sn1-specificdiacylglycerollipasebeta-likeisoformX2[Galleriamellonella]
XP_031768153.1sn1-specificdiacylglycerollipasebeta-likeisoformX1[Galleriamellonella]
XP_031768152.1sn1-specificdiacylglycerollipasebeta-likeisoformX1[Galleriamellonella]
XP_026753806.2sn1-specificdiacylglycerollipasealpha-like,partial[Galleriamellonella]
XP_026750304.2lipase 1-like[Galleriamellonella]
XP_031768044.1lipase3-like[Galleriamellonella]
XP_031767964.1lipase3-like[Galleriamellonella]
XP_031767944.1lipase 1-like[Galleriamellonella]
XP_031767816.1lipasememberH-like[Galleriamellonella]
XP_031766862.1lipase1-like[Galleriamellonella]
XP_031766858.1lipase3-like[Galleriamellonella]
XP_031766804.1hormone-sensitivelipaseisoformX2[Galleriamellonella]
XP_031766803.1hormone-sensitivelipaseisoformX1[Galleriamellonella]
XP_031765331.1lipase3-like[Galleriamellonella]
XP_031765303.1lipase1-likeisoformX2[Galleriamellonella]
XP_026748701.2lipase 1-like[Galleriamellonella]
XP_031765021.1lipase3-like[Galleriamellonella]
XP_026751643.2lipase3-like[Galleriamellonella]
XP_026756968.2lipase3-like[Galleriamellonella]
XP_031762870.1lipasememberH-A-like[Galleriamellonella
XP_026752178.2lipasememberH-A[Galleriamellonella]
XP_026761354.2lipase3-like[Galleriamellonella]
XP_026758376.1phosphatidylserinelipaseABHD16A[Galleriamellonella]
AAB09081.1yolkprotein2,partial[Galleriamellonella]
XP_026752296.1 pancreaticlipase-relatedprotein2[Galleriamellonella]
XP_026751883.1pancreaticlipase-relatedprotein2isoformX1[Galleriamellonella]
XP_026751482.1 pancreaticlipase-relatedprotein2-like[Galleriamellonella]
XP_026751172.1pancreatictriacylglycerollipase-likeisoformX2[Galleriamellonella]
XP_026751171.1pancreatictriacylglycerollipase-likeisoformX 1[Galleriamellonella]
XP_026749934.1pancreaticlipase-relatedprotein2-like[Galleriamellonella]
XP_026749862.1pancreaticlipase-relatedprotein2-like[Galleriamellonella]
XP_026749001.1pancreaticlipase-relatedprotein2-like[Galleriamellonella]
XP_026764696.1pancreatictriacylglycerollipase-like[Galleriamellonella]
XP_026758700.1pancreatictriacylglycerollipase-like[Galleriamellonella]
XP_026758657.1pancreatictriacylglycerollipase-likeisoformX1[Galleriamellonella]
XP_026758656.1pancreaticlipase-relatedprotein2-like[Galleriamellonella]
XP_026752234.1pancreaticlipase-relatedprotein3-like[Galleriamellonella]
XP_026751884.1inactivepancreaticlipase-relatedprotein1-like[Galleriamellonella]
XP_026750752.1pancreatictriacylglycerollipase-like[Galleriamellonella]
XP_026749599.1phospholipaseA 12-like[Galleriamellonella]
XP_026749596.1phospholipaseA1-like[Galleriamellonella]
XP_026764975.1gastrictriacylglycerollipase-like[Galleriamellonella]
XP_026762812.1pancreaticlipase-relatedprotein2-like[Galleriamellonella]
XP_026762735.1pancreaticlipase-relatedprotein2-like[Galleriamellonella]
XP_026759419.1pancreaticlipase-relatedprotein2-like,partial[Galleriamellonella]
XP_026758701.1pancreatictriacylglycerollipase-like[Galleriamellonella]
XP_026751801.1phospholipaseA1VesT1.02-like[Galleriamellonella]
XP_026751770.1pancreatictriacylglycerollipase-like[Galleriamellonella]

### Carboxylesterases Enzymes

XP_026756455.1carboxylesterase 1E[Galleriamellonella]
XP_031769200.1carboxylesterase4A[Galleriamellonella]
XP_031767734.1carboxylesterase4AisoformX2[Galleriamellonella]
XP_026748996.1palmitoleoyl-proteincarboxylesteraseNOTUM[Galleriamellonella]
XP_026759684.1carboxylesterase4AisoformX3[Galleriamellonella]
XP_026759683.1carboxylesterase5AisoformX1[Galleriamellonella]
XP_026753176.1esteraseE4-likeisoformX1[Galleriamellonella]
XP_026751916.1esteraseFE4-likeisoformX2[Galleriamellonella]
XP_026751915.1esteraseFE4-likeisoformX2[Galleriamellonella]
XP_026751914.1esteraseB1-likeisoformX1[Galleriamellonella]
XP_026751862.1juvenilehormoneepoxidehydrolase-like[Galleriamellonella]
XP_026749629.1esteraseB1-like[Galleriamellonella]
XP_026749628.1esteraseB1-likeisoformX1[Galleriamellonella]
XP_026749627.1esteraseFE4-like[Galleriamellonella]
XP_026749626.1esteraseFE4-like[Galleriamellonella]
XP_026749625.1uncharacterizedproteinLOC113510370 [Galleriamellonella]
XP_026749564.1esteraseFE4-like[Galleriamellonella]
XP_026749562.1esteraseFE4-like[Galleriamellonella]
XP_026749415.1 serinehydrolase-likeprotein2[Galleriamellonella]
XP_026749410.1 serinehydrolase-likeproteinisoformX2[Galleriamellonella]
XP_026749408.1 serinehydrolase-likeprotein2isoformX1[Galleriamellonella]
XP_026749363.1 serinehydrolase-likeprotein[Galleriamellonella]
XP_026749035.1juvenilehormoneesterase-like[Galleriamellonella]
XP_026748487.1esteraseE4-like[Galleriamellonella]
XP_026748486.1 venomcarboxylesterase-6-likeisoformX2[Galleriamellonella]
XP_026748484.1 venomcarboxylesterase-6-likeisoformX1[Galleriamellonella]
XP_026748442.1esteraseE4-likeisoformX1[Galleriamellonella]
XP_026765361.lepoxidehydrolase4-like[Galleriamellonella]
XP_026764291.1neuroligin-4,Y-linked [Galleriamellonella]
XP_026764290.1 uncharacterizedproteinLOC113522706[Galleriamellonella]
XP_026763078.1acetylcholinesterase-like[Galleriamellonella]
XP_026763028.1esteraseFE4-like[Galleriamellonella]
XP_026763027.1esteraseFE4-like[Galleriamellonella]
XP_026762565.1esteraseFE4-like[Galleriamellonella]
XP_026762526.1acyl-proteinthioesterase1[Galleriamellonella]
XP_026762525.1acyl-proteinthioesterase1[Galleriamellonella]
XP_026761831.1probableserinehydrolase [Galleriamellonella]
XP_026761182.1juvenilehormoneepoxidehydrolase-like[Galleriamellonella]
XP_026760793.1 venomcarboxylesterase-6-like[Galleriamellonella]
XP_026759759.1 valacyclovirhydrolase [Galleriamellonella]
XP_026757340.1neuroligin-1[Galleriamellonella];
XP_026755582.1acetylcholinesteraseisoformX1[Galleriamellonella];
XP_026753865.1juvenilehormoneesterase-like[Galleriamellonella].

Sequences of functionally characterized enzymes are described by and incorporated by reference to the following accession numbers: HiC-Humicola-insolens-4OYY; TfCut2*-T.fusca-4CG1; TfCut1-T.fusca-CBY05529; Cut-2.KW3-T.fusca-CBY05530.1; Cut-1-T.fusca-AET05798.1; Cut-2-T.fusca-AET05799.1; Thc-Cut1-T.cellulosilytica-ADV92526.1; Thc-Cut2*-T.cellulosilytica-ADV92527.1; Cutinase-S.viridis-BAO42836.1; Cut 190*-S.viridis-4WFJ; Cut 190*-S.viridis-5ZNO_B; Cutinase-P.fluorescens-KPU59139.1; Cutinase-F.oxysporum-EWY89832.1; Cutinase-3-F.oxysporum-EXK81749.1; LCC-uncultured-bacterium-AEV21261.1; PET6-V.gazogenes-SHF85073.1; Est2-T.alba-BAK48590.1; Est1*-T.alba-BA199230.2; PE-H-Y250S-P.acstusnigri-6SCD_B; PE-H-Y250S-P.acstusnigri-6SCD_A; Thf42_Cut1-T.fusca-ADV92528.1; Tha-Cut1-T.alba-ADV92525.1; TfAXE-T.fusca-ADM47605.1; Tcur_1278-T.curvata-ACY96861.1; Tcur0390*-T.curvata-ACY95991.1; Cbotu-EstA*-C.botulinum-5AH1; BTA-1 (TfH)*-T.fusca-CAH17553.1; BTA-2-T.fusca-CAH17554.1; PETase-I.sakaiensis-GAP38373.1; lipIAF5-2-Uncultured-bacteria-ACC95208.1; PET5-O.antarctica-RB-8-CCK74972.1; PET12-P.brachysporum-AKJ29164.1; LipaseA-S.exfoliatus-1JFR|A; LipaseB-S.exfoliatus|1JFR|B; Tfu_0882-T.fusca-AAZ54920.1; Tfu_0883*-T.fusca-AAZ54921.1; CALB-C.antarctica-P41365; serine.hydrolase-T.halotolerans-AFA45122.1, MnP-P.chrysosporium-Q02567.1; MHETase-I.sakaiensis-A0A0K8P8E7; or Laccase-R.ruber-AXY52693.1. Each of the above-mentioned sequences is described by and incorporated by reference to the corresponding accession number above.

Terminology. Terminology used herein is for the purpose of describing particular embodiments only and is not intended to be limiting of the invention.

Unless expressly stated, the terms used herein are intended to have the plain and ordinary meaning as understood by those of ordinary skill in the art.

The following definitions are intended to aid the reader in understanding the present disclosure but are not intended to vary or otherwise limit the meaning of such terms unless specifically indicated.

While aspects of the present disclosure have been described in conjunction with the specific embodiments thereof that are proposed as examples, alternatives, modifications, and variations to the examples may be made. The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the compositions and methods of this technology and, unless explicitly stated otherwise, are not intended to be a representation that given embodiments of this technology have, or have not, been made or tested.

As used herein, the words “preferred” and “preferably” refer to embodiments of the technology that afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the technology.

It should be noted that, as used in the specification and the appended claims, the singular forms “a,” “an,” and “the” include plural referents unless the context clearly dictates otherwise. See Harari v. Lee, 656 F.3d 1331, 1341, (Fed. Cir. 2011); Baldwin Graphic Sys., Inc. v. Siebert, Inc., 512 F.3d 1338, 1342 (Fed. Cir. 2008)); KJC Corp. v. Kinetic Concepts, Inc., 223 F.3d 1351, 1356 (Fed. Cir. 2000).

As used herein, the term “and/or” includes any and all combinations of one or more of the associated listed items and may be abbreviated as “/”. A and/or B includes A, B, and (A+B).

As used herein in the specification, the phrase “about” or “approximately” may be used when describing magnitude and/or position to indicate that the value and/or position described is within a reasonable expected range of values and/or positions. A reasonable range of values based on the disclosure and file history should be used when an express numerical range is not recited.

A numeric value may also be expressly defined by a numeric range, such as a value that is +/−0.1% of the stated value (or range of values), +/−0.2% of the stated value (or range of values), +/−0.5% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), +/−20% of the stated value (or range of values), etc.

Any numerical range recited herein is intended to include all sub-ranges and values subsumed therein. Where a range of values is provided, it is to be understood that each intervening value between an upper and lower limit of the range and any other stated or intervening value in that stated range is encompassed within the disclosure. Where the stated range includes upper and lower limits, ranges excluding either of those limits are also included.

Disclosure of values and ranges of values for specific parameters (such as temperatures, molecular weights, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if parameter X is exemplified herein to have values in the range of 1-10 it also describes subranges for Parameter X including 1-2, 1-3, 1-4, 1-5, 1-6, 1-7, 1-8, 1-9, 2-3, 2-4, 2-5, 2-6, 2-7, 2-8, 2-9, 2-10, 3-4, 3-5, 3-6, 3-7, 3-8, 3-9, 3-10, 4-5, 4-6, 4-7, 4-8, 4-9, 4-10, 5-6, 5-7, 5-8, 5-9, 5-10, 6-7, 6-8, 6-9, 6-10, 7-8, 7-9, 7-10, 8-9, 8-10, 9-10 as some examples. A range encompasses its endpoints as well as values inside of an endpoint, for example, the range 0-5 includes 0, >0, 1, 2, 3, 4, <5 and 5.

As referred to herein, all compositional percentages are by weight of the total composition, unless otherwise specified. As used herein, the word “include,” and its variants, is intended to be non-limiting, such that recitation of items in a list is not to the exclusion of other like items that may also be useful in the materials, compositions, devices, and methods of this technology. Similarly, the terms “can” and “may” and their variants are intended to be non-limiting, such that recitation that an embodiment can or may comprise certain elements or features does not exclude other embodiments of the present invention that do not contain those elements or features.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

All publications and patent applications mentioned in this specification are herein incorporated by reference in their entirety to the same extent as if each individual publication or patent application was specifically and individually indicated to be incorporated by reference, especially referenced is disclosure appearing in the same sentence, paragraph, page or section of the specification in which the incorporation by reference appears.

The citation of references herein does not constitute an admission that those references are prior art or have any relevance to the patentability of the technology disclosed herein. Any discussion of the content of references cited is intended merely to provide a general summary of assertions made by the authors of the references and does not constitute an admission as to the accuracy of the content of such references.

Sequences of Wax Moth candidate enzymes and their respective accession numbers. As described elsewhere in this disclosure, these sequences provide basis for producing enzymatically active fragments or variants, such as amino acid sequences variants having at least 60-99% sequence identity or similarity to the sequences described below or to genes or variant polynucleotides encoding the amino acid sequences disclosed below. Such sequences, their fragments or domains, or variants may be expressed, or recombinantly expressed, and used in the plastic degrading methods disclosed herein. The sequences below are described by and incorporated by reference to the corresponding accession numbers. New versions of these accession numbers or replacement accession numbers for withdrawn accession numbers known as of the filing date of this application are specifically contemplated.

1. A method for degrading plastic comprising:
contacting a plastic with one or more plastic-degrading enzymes encoded by the genome of the order Lepidoptera, or an enzymatically active fragment or domain thereof, or an enzymatically active variant thereof having at least 60, 65, 70, 75, 80, 85, 90, 95, 99, <100, or 100% sequence identity thereto, for a time and under conditions suitable for degrading the plastic.

2. The method of claim 1, wherein the one or more plastic degrading are encoded by the genome of the order Lepidoptera

3. The method of claim 1, wherein the plastic comprises low density polyethylene (LDPE) or high density polyethylene (HDPE).

4. The method of claim 1, wherein the plastic comprises polyethylene terephthalate (PET).

5. The method of claim 1, wherein the plastic comprises polylactic acid (PLA).

6. The method of claim 1, wherein the plastic comprises mono(2-hydroxyethyl) terephthalate (MHET).

7. The method of claim 1, wherein the plastic comprises polypropylene (PP), polystyrene (PS), and/or polyvinyl chloride (PVC).

8. The method of claim 1, wherein the one or more plastic degrading enzymes are expressed by Galleria mellonella.

9. The method of claim 1, wherein the one or more plastic degrading enzymes comprise at least one sequence selected from the group consisting of SEQ ID NOS: 5-9.

10. The method of claim 1, wherein the one or more enzymes comprise a catalytic triad of amino acid residues consisting of Ser, His and Asp, substantially as aligned with a triad of amino acid residues consisting of Ser160, His237 and Asp206 in the poly(ethylene terephthalate)ase (PETase) of Ideonella sakaiensis or Piscinibacter sakaiensis accession number GAP38373 (SEQ ID NO: 10).

11. The method of claim 1, further comprising physically, photonically, chemically, or biologically degrading the plastic during or prior to contacting it with the one or more enzymes.

12. An engineered enzyme that has an amino acid sequence that is at least 95% but <100% identical to an enzyme expressed in the order Lepidoptera that degrades plastic, or an enzymatically active fragment or domain or variant thereof.

13. The engineered enzyme of claim 12 that digests or degrades low density polyethylene (LDPE) or high density polyethylene (HDPE).

14. The engineered enzyme of claim 12 that digests or degrades polyethylene terephthalate (PET) and/or polylactic acid (PLA).

15. The engineered enzyme of claim 12 that digests or degrades mono(2-hydroxyethyl) terephthalate (MHET).

16. The engineered enzyme of claim 12 that digests or degrades polypropylene PP, PS and/or PVC.

17. The engineered enzyme of claim 12 that comprises SEQ ID NO: 5, 6, 7, 8 or 9 or a sequence that is at least 95% identical to SEQ ID NO: 5, 6, 7, 8 or 9 or an enzymatically active fragment thereof.

18. The engineered enzyme of claim 12 that comprises a catalytic triad of amino acid residues consisting of Ser, His and Asp, substantially as aligned with a triad of amino acid residues consisting of Ser160, His237 and Asp206 in the poly(ethylene terephthalate)ase (PETase) of Ideonella sakaiensis or Piscinibacter sakaiensis accession number GAP38373 (SEQ ID NO: 10).

19. An engineered cell or organism transformed with a nucleic acid sequence encoding an engineered enzyme according to claim 12.

20. A composition comprising a plastic-degrading enzyme expressed by the order Lepidoptera or a fragment or domain thereof, or an engineered enzyme that has an amino acid sequence that is at least 95% identical and <100% identical to an enzyme expressed by the genome of the order Lepidoptera and at least enzymatic stabilizer or active ingredient that accelerates the degradation of the plastic.
